(19) United States
(12) Patent Application Publication
(10) Pub. No.: US 2026/0300443 A1
(43) Pub. Date: Oct. 1, 2026

(54) COMPUTING SYSTEM AND METHOD FOR CREATING A MACHINE LEARNING MODEL HAVING IMPROVED FAIRNESS

(71) Applicant: Capital One Financial Corporation, McLean, VA (US)

(72) Inventors: Alexey Miroshnikov, Scottsdale, AZ (US); Ryan Franks, Deerfield, IL (US)

(21) Appl. No.: 19/273,008

(22) Filed: Jul. 17, 2025

Related U.S. Application Data
(60) Provisional application No. 63/781,092, filed on Mar. 31, 2025.

(51) Int. Cl. G06F 18/2451; G06N 20/00

(52) U.S. Cl. CPC G06F 18/2451; G06N 20/00

(57) ABSTRACT

A computing platform installed with executable software for producing a fairer version of a machine learning (ML) model that is configured to output a predicted value for a numerical variable, where the computing platform is programmed to (i) initialize a subpopulation-dependent fairer version of the ML model, (ii) train a subpopulation-independent projection of the subpopulation-dependent fairer ML model, (iii) evaluate multiple candidate instances of a subpopulation-independent fairer version of the ML model comprising a linear combination of (a) an unadjusted predicted value for the numerical variable that is output by the ML model and (b) a fairness-adjusted predicted value for the numerical variable that is output by the subpopulation-independent projection, and (iv) based on evaluating the multiple candidate instances of the subpopulation-independent fairer ML model, select a given candidate instance of the subpopulation-independent fairer ML model that is thereafter deployed.

### CROSS-REFERENCE TO RELATED APPLICATIONS

This application claims priority under 35 U.S.C. § 119(e) to U.S. Provisional Application No. 63/781,092, which was filed on Mar. 31, 2025 and is entitled “EXPLAINABLE POST-TRAINING BIAS MITIGATION WITH DISTRIBUTION-BASED FAIRNESS METRICS,” the contents of which are incorporated by reference herein in their entirety.

### BACKGROUND

Whenever a company's business requires business decisions to be made with respect to particular individuals, such as decisions as to whether to extend certain services or offer certain financial terms to particular individuals, there is a risk that the company's decision-making practices could incorporate some form of bias, whether intentionally or inadvertently. For instance, a company's decision-making practices may be at risk of incorporating a bias that unfairly favors individuals belonging to one subpopulation over individuals belonging to one or more other subpopulations. The distinction between different subpopulations of individuals (which may sometimes be referred to as different “groups” or “classes” of individuals) may be defined based on any of various attributes, examples of which may include gender, race, age, sexual orientation, gender identity, religion, and/or marital status, among other possibilities.

In view of this risk of possible bias, various regulations now exist that prohibit companies from engaging in decision-making practices that unfairly favor individuals belonging to one subpopulation over individuals belonging to one or more other subpopulations. In some cases, these regulations may prohibit decision-making practices that unfairly favor any one subpopulation of individuals over another, regardless of the legal status of the subpopulations, while in other cases, these regulations may be specifically focused on protecting certain legally-protected subpopulations of individuals, such as minorities, females, older age groups, etc., as compared to other subpopulations.

One example of such a regulation is the Equal Credit Opportunity Act (ECOA), which prohibits companies that extend credit from discriminating against individuals seeking credit based on attributes such as gender, race, color, religion, national origin, marital status, age, public assistance, or the exercise of any rights under the Consumer Credit Protection Act. Under the ECOA, a company that extends credit must undergo something called a fair lending review during which the company's decision-making practices are evaluated to ensure compliance the anti-discriminatory provisions of the ECOA, and if those decision-making practices incorporate any improper bias, the company must then alter its decision-making practices to mitigate that bias.

Along similar lines, a company may need to review its decision-making practices for improper bias (and potentially mitigate that bias) in order to ensure compliance with other applicable regulations and/or internal company policies, among other possibilities.

### Overview

Disclosed herein is new technology for producing a fairer version of a trained machine learning model (i.e., a machine learning model having reduced bias) that improves upon prior technology for reducing the bias of a trained machine learning model.

In one aspect, the disclosed technology may take the form of a method to be carried out by a computing platform that involves (i) utilizing a first machine learning process to train a machine learning model that is configured to (a) receive an input record comprising feature values for an input set of features and (b) output an unadjusted predicted value for at least one numerical variable, (ii) initializing a subpopulation-dependent fairer version of the trained machine learning model that is configured to (a) receive an input record comprising feature values for the input set of features and a subpopulation value indicating that the input record is associated with a particular subpopulation from a group of distinct subpopulations and (b) output a fairness-adjusted predicted value for the at least one numerical variable that is dependent on the subpopulation value, (iii) utilizing a second machine learning process to train a subpopulation-independent projection of the subpopulation-dependent fairer version of the trained machine learning model that is configured to (a) receive an input record comprising feature values for the input set of features and (b) output a fairness-adjusted predicted value for the at least one numerical variable without relying on any subpopulation value, (iv) evaluating multiple candidate instances of a subpopulation-independent fairer version of the trained machine learning model comprising a linear combination of (a) an unadjusted predicted value for the at least one numerical variable that is output by the trained machine learning model and (b) a fairness-adjusted predicted value for the at least one numerical variable that is output by the subpopulation-independent projection, wherein each respective candidate instance of the subpopulation-independent fairer version of the trained machine learning model applies a different weighting to the unadjusted and fairness-adjusted predicted values within the linear combination, and (v) based on evaluating the multiple candidate instances of the subpopulation-independent fairer version of the trained machine learning model, selecting a given candidate instance of the subpopulation-independent fairer version of the trained machine learning model, which may thereafter be deployed and utilized to output predicted values of the at least one numerical variable.

The trained machine learning model for which the subpopulation-independent fairer version is produced may take any of various forms, and in at least some embodiments, the trained machine learning model may be configured to output an unadjusted predicted value for a numerical variable that takes the form of a classification score for use in making a binary classification prediction between a positive outcome and a negative outcome.

Further, the second machine learning process that is utilized to train the subpopulation-independent projection of the subpopulation-dependent fairer version of the trained machine learning model may take any of various forms, and in at least some embodiments where the at least one numerical variable that takes the form of a classification score for use in making a binary classification prediction between a positive outcome and a negative outcome, the second machine learning process may comprise a machine learning process involving a supervised learning technique that minimizes a weighted loss function, such as a weighted loss function quantifies performance loss in terms of binary cross-entropy. And in such embodiments, the second machine learning process may be applied to a collection of training-record pairs, where each respective training-record pair comprises: (1) a first training record containing a respective set of feature values for the input set of features, a first label for a positive outcome, and a first weight comprising a fairness-adjusted classification score output by the subpopulation-dependent fairer version of the trained machine learning model for the respective set of feature values given a corresponding subpopulation value; and (2) a second training record containing the respective set of feature values for the input set of features, a second label for a negative outcome, and a second weight comprising a complement of the fairness-adjusted classification score output by the subpopulation-dependent fairer version of the trained machine learning model for the respective set of feature values given the corresponding subpopulation value.

Further yet, the subpopulation-dependent fairer version of the trained machine learning model may take any of various forms, and in at least some embodiments, the subpopulation-dependent fairer version of the trained machine learning model may comprise a mapping function that is configured to map an unadjusted classification score output by the trained machine learning model to a point along a distribution of fairness-adjusted classification scores that constitutes a combination of subpopulation-specific distributions of unadjusted classification scores output by the trained machine learning model for the group of distinct subpopulations (e.g., a weighted Wasserstein-2 barycenter).

Still further, the subpopulation-independent projection of the subpopulation-dependent fairer version of the trained machine learning model may take any of various forms, and in at least some embodiments, the subpopulation-independent projection of the subpopulation-dependent fairer version of the trained machine learning model may comprise a trained machine learning model having an output that is explainable by a model explainability technique.

Still further yet, the function of evaluating the multiple candidate instances of the subpopulation-independent fairer version of the trained machine learning model may take various forms, and in at least some embodiments, may involve evaluating the multiple candidate instances of the subpopulation-independent fairer version of the trained machine learning model based on respective performance and bias values that are determined for each of the multiple candidate instances of the subpopulation-independent fairer version of the trained machine learning model.

The foregoing method may also involve additional functionality. For instance, in at least some embodiments, the foregoing method may additionally involve (i) after deploying the given candidate instance of the subpopulation-independent fairer version of the trained machine learning model, utilize the given candidate instance of the subpopulation-independent fairer version of the trained machine learning model to render predictions comprising predicted values of the at least one numerical variable for individuals or other entities within a population comprising the group of distinct subpopulations, and (ii) for each of at least a subset of the predictions rendered by the given candidate instance of the subpopulation-independent fairer version of the trained machine learning model, utilize a model explainability technique to explain the prediction.

In another aspect, disclosed herein is a computing platform that includes a communication interface for communicating over at least one data network, at least one processor, at least one non-transitory computer-readable medium, and program instructions stored on the at least one non-transitory computer-readable medium that are executable by the at least one processor to cause the computing platform to carry out the functions disclosed herein, including but not limited to the functions of the foregoing method.

In yet another aspect, disclosed herein is a non-transitory computer-readable medium provisioned with program instructions that, when executed by at least one processor, cause a computing platform to carry out the functions disclosed herein, including but not limited to the functions of the foregoing method.

One of ordinary skill in the art will appreciate these as well as numerous other aspects in reading the following disclosure.

### BRIEF DESCRIPTION OF THE DRAWINGS

FIG. 1 is a simplified block diagram illustrating an example computing environment in which a data science model such as a machine learning model may be trained and/or executed.

FIG. 2 is a simplified block diagram illustrating an example software-based pipeline for creating a machine learning model having reduced bias in accordance with the present disclosure.

FIG. 3A shows two examples of empirical subpopulation-specific cumulative distribution functions (CDFs) that may be pre-constructed and stored by the example software-based pipeline of FIG. 2.

FIG. 3B shows an example of an empirical quantile function for a distribution of fairness-adjusted classification scores that may be pre-constructed and stored by the example software-based pipeline of FIG. 2.

FIG. 4 illustrates one possible example of generating a projection training dataset for use in training a subpopulation-independent projection of a subpopulation-dependent fairer model in accordance with the present disclosure.

FIG. 5 illustrated is a two-dimensional graph that illustrates one representative example of performance and bias values that may be determined for candidate instances of a subpopulation-independent fairer model constructed in accordance with the present disclosure.

FIG. 6 is a flow chart that illustrates one possible example of functionality for creating a machine learning model having reduced bias in accordance with the present disclosure.

FIG. 7 is a simplified block diagram that illustrates some structural components of an example computing platform.

### DETAILED DESCRIPTION

Organizations in various industries have begun to utilize data science models to help make certain business decisions with respect to prospective or existing customers of those companies. For instance, as one possibility, an organization may utilize a data science model to help make decisions regarding whether to extend a service provided by that organization to a particular individual. One example may be an organization that provides financial services such as loans, credit card accounts, bank account, or the like, which may utilize a data science model to help make decisions regarding whether to extend one of these financial services to a particular individual (e.g., by deciding whether to approve or deny an application submitted by the individual). As another possibility, an organization may utilize a data science model to help make decisions regarding whether to target a particular individual when engaging in marketing of a good and/or service that is provided by the company. As yet another possibility, a company may utilize a data science model to help make decisions regarding what terms to offer a particular individual for a service provided by the organization, such as what interest rate level to offer a particular individual for a new loan or a new credit card account. Many other examples are possible as well.

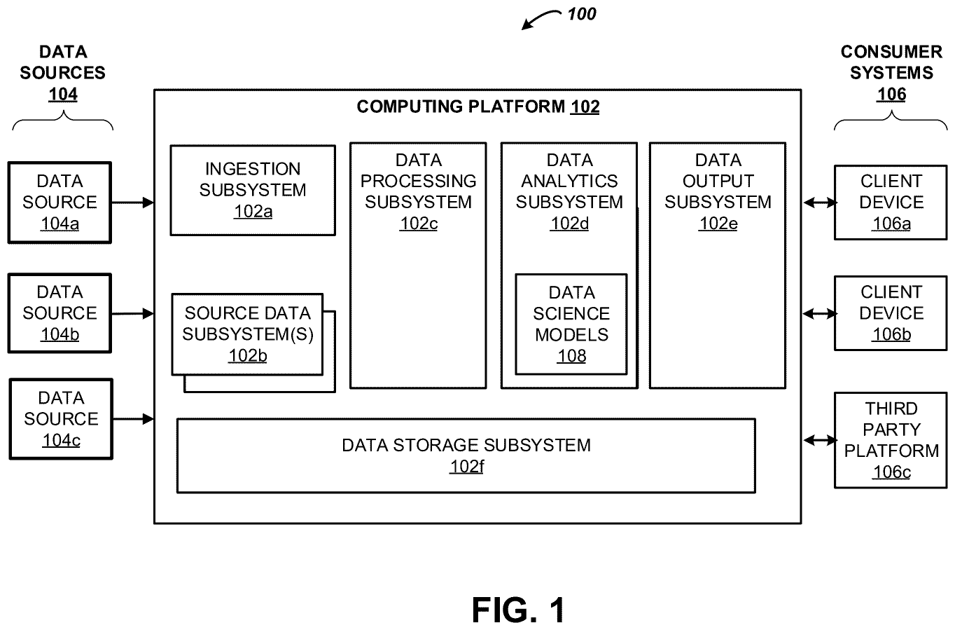

One illustrative example of a computing environment 100 in which an example data science model such as this may be utilized is shown in FIG. 1. As shown, the example computing environment 100 may include a computing platform 102 associated with a given organization, which may comprise various functional subsystems that are each configured to perform certain functions in order to facilitate tasks such as data ingestion, data generation, data processing, data analytics, data storage, and/or data output. These functional subsystems may take various forms.

For instance, as shown in FIG. 1, the example computing platform 102 may comprise an ingestion subsystem 102a that is generally configured to ingest source data from a particular set of data sources 104, such as the three representative data sources 104a, 104b, and 104c shown in FIG. 1, over respective communication paths. These data sources 104 may take any of various forms, which may depend at least in part on the type of organization operating the example computing platform 102.

Further, as shown in FIG. 1, the example computing platform 102 may comprise one or more source data subsystems 102b that are configured to internally generate and output source data that is consumed by the example computing platform 102. These source data subsystems 102b may take any of various forms, which may depend at least in part on the type of organization operating the example computing platform 102.

Further yet, as shown in FIG. 1, the example computing platform 102 may comprise a data processing subsystem 102c that is configured to carry out certain types of processing operations on the source data. These processing operations could take any of various forms, including but not limited to data preparation, transformation, and/or integration operations such as validation, cleansing, deduplication, filtering, aggregation, summarization, enrichment, restructuring, reformatting, translation, mapping, etc.

Still further, as shown in FIG. 1, the example computing platform 102 may comprise a data analytics subsystem 102d that is configured to carry out certain types of data analytics operations based on the processed data in order to derive insights, which may depend at least in part on the type of organization operating the example computing platform 102. For instance, in line with the present disclosure, data analytics subsystem 102d may be configured to execute data science models 108 for rendering decisions related to the organization's business, such as a data science model for deciding whether to extend a service being offered by the organization to an individual within a population comprising one or more protected subpopulations (e.g., a financial service such as a loan, a credit card account, a bank account, etc.), a data science model for deciding whether to target an individual within a population comprising one or more protected subpopulations when engaging in marketing of a good and/or service that is offered by the organization, and/or a data science model for deciding what terms to extend an individual within a population comprising one or more protected subpopulations for a service being offered by the organization, among various other possibilities. In practice, each such data science model 108 may comprise a machine learning model that was trained by applying a machine learning process to a training dataset, although it should be understood that a data science model could take various other forms as well.

Referring again to FIG. 1, the example computing platform 102 may also comprise a data output subsystem 102e that is configured to output data (e.g., processed data and/or derived insights) to certain consumer systems 106 over respective communication paths. These consumer systems 106 may take any of various forms.

For instance, as one possibility, the data output subsystem 102e may be configured to output certain data to client devices that are running software applications for accessing and interacting with the example computing platform 102, such as the two representative client devices 106a and 106b shown in FIG. 1, each of which may take the form of a desktop computer, a laptop, a netbook, a tablet, a smartphone, or a personal digital assistant (PDA), among other possibilities. These client devices may be associated with any of various different types of users, examples of which may include individuals that work for or with the organization (e.g., employees, contractors, etc.) and/or individuals seeking to obtain goods and/or services from the organization. As another possibility, the data output subsystem 102e may be configured to output certain data to other third-party platforms, such as the representative third-party platform 106c shown in FIG. 1.

In order to facilitate this functionality for outputting data to the consumer systems 106, the data output subsystem 102e may comprise one or more Application Programming Interface (APIs) that can be used to interact with and output certain data to the consumer systems 106 over a data network, and perhaps also an application service subsystem that is configured to drive the software applications running on the client devices, among other possibilities.

The data output subsystem 102e may be configured to output data to other types of consumer systems 106 as well.

Referring once more to FIG. 1, the example computing platform 102 may also comprise a data storage subsystem 102f that is configured to store all of the different data within the example computing platform 102, including but not limited to the source data, the processed data, and the derived insights. In practice, this data storage subsystem 102f may comprise several different data stores that are configured to store different categories of data. For instance, although not shown in FIG. 1, this data storage subsystem 102f may comprise one set of data stores for storing source data and another set of data stores for storing processed data and derived insights. However, the data storage subsystem 102f may be structured in various other manners as well. Further, the data stores within the data storage subsystem 102f could take any of various forms, examples of which may include relational databases (e.g., Online Transactional Processing (OLTP) databases), NoSQL databases (e.g., columnar databases, document databases, key-value databases, graph databases, etc.), file-based data stores (e.g., Hadoop Distributed File System), object-based data stores (e.g., Amazon S3), data warehouses (which could be based on one or more of the foregoing types of data stores), data lakes (which could be based on one or more of the foregoing types of data stores), message queues, and/or streaming event queues, among other possibilities.

The example computing platform 102 may comprise various other functional subsystems and take various other forms as well.

In practice, the example computing platform 102 may generally comprise some set of physical computing resources (e.g., processors, data storage, communication interfaces, etc.) that are utilized to implement the functional subsystems discussed herein. This set of physical computing resources take any of various forms. As one possibility, the computing platform 102 may comprise cloud computing resources that are supplied by a third-party provider of “on demand” cloud computing resources, such as Amazon Web Services (AWS), Amazon Lambda, Google Cloud Platform (GCP), Microsoft Azure, or the like. As another possibility, the example computing platform 102 may comprise “on-premises” computing resources of the organization that operates the example computing platform 102 (e.g., organization-owned servers). As yet another possibility, the example computing platform 102 may comprise a combination of cloud computing resources and on-premises computing resources. Other implementations of the example computing platform 102 are possible as well.

Further, in practice, the functional subsystems of the example computing platform 102 may be implemented using any of various software architecture styles, examples of which may include a microservices architecture, a service-oriented architecture, and/or a serverless architecture, among other possibilities, as well as any of various deployment patterns, examples of which may include a container-based deployment pattern, a virtual-machine-based deployment pattern, and/or a Lambda-function-based deployment pattern, among other possibilities.

It should be understood that computing environment 100 is one example of a computing environment in which a data science model may be utilized, and that numerous other examples of computing environment are possible as well.

Implementing a computing platform that executes machine learning models like those described above to help make business decisions with respect to individuals and/or other entities within a population comprising one or more protected subpopulations may provide various advantages over conventional approaches for making business decisions, such as approaches in which one or more employees of an organization are tasked with reviewing some set of available information about an individual or other entity within a population and then making a business decision with respect to that individual. These advantages may include (i) reducing the time it takes to make business decisions, (ii) expanding the scope and depth of the information that can be practically evaluated when making business decisions, which leads to better-informed decisions, (iii) reaching decisions in a more objective, reliable, and repeatable way, and (iv) avoiding any bias that could otherwise be introduced (whether intentionally or subconsciously) by employees that are involved in the decision-making process, among other possibilities.

However, when an organization is utilizing machine learning models to help make business decisions with respect to individuals and/or other entities within a population comprising one or more protected subpopulations, this increases the difficulty of evaluating the organization's decision-making practices for improper bias (e.g., as part of a fair lending review under the ECOA) and then mitigating any such bias—particularly as the machine learning models being utilized become more complex. For instance, one example of such a machine learning model comprises a complex, trained object that is configured to (i) receive input data for some input set of feature variables, (ii) evaluate the input data, and (iii) based on the evaluation, output a predicted value for a numerical variable (e.g., a classification score) that is then used make a decision regarding an individual or entity, such by comparing a classification score to a specified score threshold. There are some existing techniques available for evaluating whether this type of machine learning model exhibits improper bias that unfairly favors one subpopulation of individuals or other entities over others, but if improper bias is detected, it is very difficult to meaningfully evaluate which aspects of the machine learning model are causing that improper bias, and even more difficult to determine or implement an effective strategy for modifying the machine learning model so as to mitigate the improper bias.

Given these difficulties, organizations that wish to utilize machine learning models to help make business decisions were initially forced into a trial-and-error type of approach, where the process of deploying a machine learning model involved iteratively training and testing multiple different versions of the machine learning model (e.g., by using different hyperparameters) until the organization was able to find a version of the machine learning model that satisfied the applicable requirements regarding bias. However, this process of iteratively training and testing multiple different versions of a machine learning model that an organization wishes to deploy until the applicable requirements regarding bias are satisfied is time consuming, labor intensive, and costly. Further, mitigating the bias of the model by training a machine learning model with altered hyperparameters typically degrades the performance of the machine learning model.

To overcome these problems, efforts have recently been made to develop more intelligent and advanced technology for creating fairer machine learning models having reduced bias. For example, certain technological approaches for creating machine learning models having reduced bias were disclosed in each of (i) U.S. Pat. No. 12,002,258, which was filed on Jun. 3, 2020 by the present Applicant and is entitled “SYSTEM AND METHOD FOR MITIGATING BIAS IN CLASSIFICATION SCORES GENERATED BY MACHINE LEARNING MODELS,” and (ii) U.S. Pat. App. Pub. No. 2022/0414766, which was filed on Aug. 31, 2022 by the present Applicant and is entitled “COMPUTING SYSTEM AND METHOD FOR CREATING A DATA SCIENCE MODEL HAVING REDUCED BIAS,” each of which are assigned to the applicant of the present application and are incorporated herein by reference in their entirety.

However, the prior technology for creating fairer machine learning models still suffers from several problems. First, the prior technology either had difficulties reducing the bias of machine learning models beyond a certain practical limit, degraded the model performance by a greater extent than is desirable in order achieve reduced bias of the machine learning models, or both, which resulted in the creation of machine learning models that had a less-than-desirable tradeoff between model performance and model bias. There are several reasons for this, including that (i) at least some of the prior technology utilized failed to utilize a true machine learning process (e.g., a model training process) as part of its process for determining how to modify the configuration of the machine learning model in a way that reduces bias while preserving acceptable performance, (ii) at least some of the prior technology attempted to reduce the bias by replacing input features of the machine learning model with transformations, but that prior technology was typically only capable of modifying a limited number of input features due to practical limitations and was also not necessarily suitable for categorical or discrete input features of the machine learning model, and (iii) at least some of the prior technology was focused on reducing the bias by adjusting the input feature variables of the machine learning model in a manner that affects the distribution of features globally as opposed to modifying the configuration of a machine learning model in a manner that impacts the bias locally (in space of features).

Second, the prior technology for creating fairer machine learning models tends to be slow, computationally expensive, and inefficient, particularly for certain types of machine learning models, which can make it difficult to utilize such prior technology in practice to create new machine learning models. There are several reasons for this, including that at least some of the prior technology utilized random or Bayesian search as part of its process for determining how to modify the configuration of the machine learning model in a way that reduces bias while preserving acceptable performance, which can be slow, computationally expensive, and inefficient in higher dimensions.

Third, at least some of the fairer machine learning models produced by the prior technology did not work well with model explainability techniques (or sometimes referred to as model interpretability techniques) that quantify the contributions of a machine learning model's input feature variables to the predictions output by the machine learning model, which made it difficult or impossible to explain the predictions output by the fairer machine learning models produced by the prior technology.

Fourth, at least some of the fairer machine learning models produced by the prior technology required an identification of the particular subpopulation(s) to which an individual or entity belonged in order to produce and output a fairer prediction for that individual or entity, and in many scenarios, it is not permissible to rely on this type of subpopulation information when rendering a prediction related to an individual or entity.

The prior technology for creating fairer machine learning models may suffer from other problems as well.

To address these and other problems, disclosed herein is new technology for creating a fairer version of a machine learning model that (i) has an improved performance-bias tradeoff relative to machine learning models that are produced using prior technology for reducing bias and (ii) can still have its outputs explained using a model explainability technique, which may be utilized when there is a desire to create a new machine learning model that is governed by bias requirements (e.g., a machine learning model that is subject to a fair lending review under the ECOA) or otherwise gives rise to bias concerns.

In accordance with the disclosed technology, a computing platform may begin by training a machine learning model having an input comprising values for a set of feature variables (or “features” for simplicity) and an output comprising a predicted value of at least one numerical variable that could give rise to bias concerns—such as a numerical variable that is utilized to make business decisions with respect to individuals or other entities from a population that includes one or more protected subpopulations (e.g., subpopulations defined based on protected attributes such as gender, race, age, sexual orientation, religion, marital status, etc.). Depending on type of machine learning model being trained, the at least one numerical variable for which predicted values are to be output by the machine learning model could take the form of a single classification score for use in making a binary classification prediction between a “positive” outcome and a “negative” outcome, multiple classification scores for use in making a classification prediction between the multiple different outcomes, or a continuous numerical variable that represents something other than a classification score, among other possibilities. Further, the machine learning model that is trained will preferably be of a type that is capable of having its output explained by a model explainability technique.

After the machine learning model is trained, the computing platform may then carry out a sequence of operations for producing a fairer version of the trained machine learning model that achieves improved fairness in its predictions relative to the trained machine learning model itself without relying on a subpopulation value as part of its input, which may be referred to herein as a “subpopulation-independent fairer model.” This sequence of operations may take any of various forms.

In at least some implementations, the computing platform may begin by initializing a “target” subpopulation-independent fairer model that comprises a linear combination of (i) the trained machine learning model and (ii) a fairer version of the trained machine learning model that does rely on a subpopulation value as part of its input, which may be referred to herein as the “subpopulation-dependent fairer model.” Notably, this target subpopulation-independent fairer model does have a term that is dependent on a subpopulation value (specifically, the subpopulation-dependent fairer model), but that term will subsequently be replaced in order to eliminate the subpopulation-independent fairer model's dependence on a subpopulation value.

Next, the computing platform may update the target subpopulation-independent fairer model in order to replace the subpopulation-dependent fairer model with a projection thereof that is trained to produce a comparable output (e.g., an approximation of a fairness-adjusted classification score) without relying on a subpopulation value as part of its input, which may be referred to as a “subpopulation-independent projection” of the subpopulation-dependent fairer model. To accomplish this, the computing platform may (i) generate a projection training dataset for use in training the subpopulation-independent projection of the subpopulation-dependent fairer model, (ii) train the subpopulation-independent projection by applying a machine learning process to the projection training dataset that is generated (e.g., a machine learning process involving a supervised learning technique that minimizes a weighted loss function for a classification type of model or an unweighted loss function for a regression type of model), where the trained subpopulation-independent projection is preferably of a type that is capable of having its output explained by a model explainability technique, and (iii) replace the subpopulation-dependent fairer model that is included in the target subpopulation-independent fairer model with the trained subpopulation-independent projection. The updated subpopulation-independent fairer model that results from this functionality may comprise a linear combination of (i) the trained machine learning model and (ii) the trained subpopulation-independent projection—where neither term is dependent upon on a subpopulation value.

Lastly, the computing platform may (i) produce multiple different candidate instances of the updated subpopulation-independent fairer model that weight the relative contributions of the trained machine learning model's output and the subpopulation-independent projection's output differently (e.g., by varying a blending coefficient that defines the relative contributions of the trained machine learning model's output and the subpopulation-independent projection's output to the updated subpopulation-independent fairer model's output) and (ii) select a given candidate instance of the updated subpopulation-independent fairer model as the version of the updated subpopulation-independent fairer model that is to be deployed and executed, which may be referred to herein as the “final fairer model” for the trained machine learning model.

The disclosed technology for creating a fairer version of a machine learning model may also involve other functionality, and is described in greater detail below.

Advantageously, the disclosed technology for creating a fairer (i.e., reduced-bias) version of a machine learning model provides a number of technological improvements over the existing technology for creating a machine learning model having reduced bias.

First, the disclosed technology produces fairer versions of machine learning models that have an improved performance-bias tradeoff relative to fairer versions of machine learning models that are produced using the existing technology—particularly when the disclosed technology is utilized to produce a fairer version of a classification type of machine learning model that is to be utilized to make classification predictions. There are several reasons for this, including that the disclosed technology produces the subpopulation-independent projection of the subpopulation-dependent fairer model by training a model utilizing a machine learning process that functions to minimize a suitable loss function (as opposed to producing an L2 projection of a subpopulation-dependent fairer model, for instance).

Second, the disclosed technology is capable of producing fairer versions of machine learning models in a faster, less computationally expensive, and/or more efficient way than the existing technology for creating fairer versions of machine learning models.

Third, the fairer versions of machine learning models that are produced by the disclosed technology are explainable, in that the predictions output by the machine learning models can be explained using a model explanation technique that quantifies the contributions of a machine learning model's input feature variables to the predictions output by the machine learning model.

Fourth, the fairer versions of machine learning models that are produced by the disclosed technology are capable of achieving improved fairness without relying on a subpopulation value as part of its input, which means that such models can still be used in scenarios where it is not permissible to rely on subpopulation information when rendering predictions.

As described in further detail below, the disclosed technology for creating a fairer (i.e., reduce-bias) version of machine learning model may provide other technological improvements over the existing technology as well.

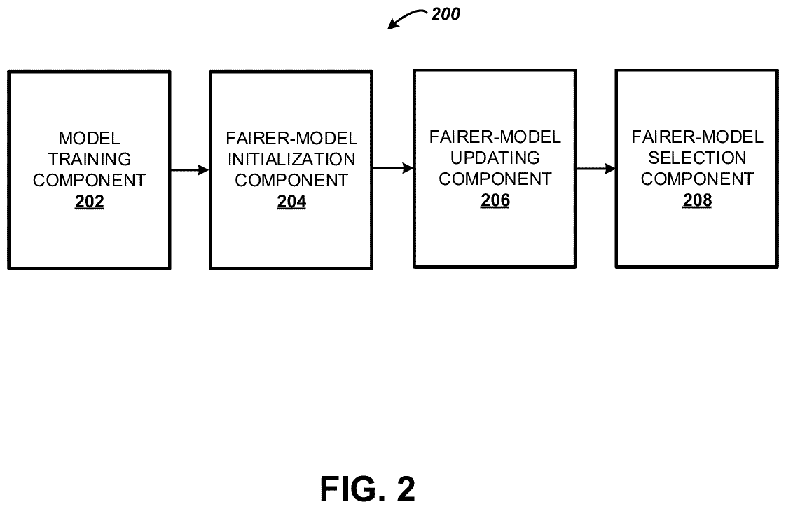

Turning now to FIG. 2, a block diagram of an example software-based pipeline 200 for creating a fairer version of a machine learning model (i.e., a machine learning model having reduced bias) in accordance with the present disclosure is shown. In practice, the example software-based pipeline 200 may comprise a set of functional components, each of which may be encoded in the form of program instructions that are executable by one or more processors of one or more computing platforms. For purposes of illustration, the example software-based pipeline 200 is described as being installed on and executed by the computing platform 102 of FIG. 1, but it should be understood that the example software-based pipeline 200 may be installed on and executed by any one or more computing platforms that are capable of performing the example operations of the example software-based pipeline 200, and in some cases, different components of the example software-based pipeline 200 may be executed by different computing platforms that communicate with one another via a network-based communication path. Further, it should be understood that the example software-based pipeline 200 is merely described in this manner for the sake of clarity and explanation and that the example operations may be implemented in various other manners, including the possibility that operations may be added, removed, rearranged into different orders, combined into fewer blocks, and/or separated into additional blocks depending upon the particular embodiment.

As shown, the example software-based pipeline 200 may comprise a model training component 202, a fairer-model initialization component 204, a fairer-model updating component 206, and a fairer-model selection component 208, among other possible components that may be included in the example software-based pipeline 200. Each of these software components will now be described in further detail.

The example software-based pipeline 200 may begin with the model training component 202, which may function to train a machine learning model having an input comprising values for a set of feature variables (or “features” for simplicity) and an output comprising a predicted value of at least one numerical variable that could give rise to bias concerns—such as a numerical variable that is utilized to make business decisions with respect to individuals or other entities from a population that includes one or more protected subpopulations (e.g., subpopulations defined based on protected attributes such as gender, race, age, sexual orientation, religion, marital status, etc.). In one embodiment of the present disclosure, the at least one numerical variable for which the machine learning is to output a predicted value may comprise a single classification score for use in making a binary classification prediction between a “positive” outcome and a “negative” outcome (e.g., by comparing the classification score to a threshold where one side of the threshold is associated with the positive outcome and the other side of the threshold is associated with the negative outcome), and the functionality of the example software-based pipeline 200 is at times described below in the context of this embodiment (which is sometimes referred to as a “binary classification” type of machine learning model). However, as discussed further below, the at least one numerical variable for which the machine learning is to output a predicted value may take other forms as well, including but not limited to the possibility that the machine learning model being trained could have an output comprising either (i) multiple classification scores for multiple different outcomes that are then used to make a classification prediction between the multiple different outcomes (which is sometimes referred to as a “multi-class classification” type of machine learning model) or (ii) a continuous numerical variable that represents something other than a classification score (which is sometimes referred to as a “regression” type of machine learning model).

In practice, the function of training the machine learning model may be carried out by applying a machine learning process for a given model type to a model training dataset comprising a collection of training records that each contains (i) a respective set of values for the machine learning model's input set of feature variables, and (ii) a corresponding ground-truth value for the classification prediction that is to be made based on the classification score output by the machine learning model (which is sometimes referred to as a “target label”). In this respect, the training records may represent different individuals or other entities from a population that gives rise to bias concerns—such as a population that includes one or more protected subpopulations (e.g., subpopulations defined based on protected attributes such as gender, race, age, sexual orientation, religion, marital status, etc.). However, it should be understood that the model training dataset could take other forms as well. For instance, as one possibility, the training records in the model training dataset could include values for additional feature variables that were utilized during training of the machine learning model but are not ultimately included in the input set of features that is defined for the trained machine learning model. As another possibility, the corresponding ground-truth values may not be contained within the training records themselves but may instead be separate data entities that are associated with the training records in some manner (e.g., via a key value, a pointer, or the like). The model training dataset may take other forms as well.

In practice, the machine learning process that is applied to such a training dataset may involve one or more supervised learning techniques that function to train a machine learning model by minimizing an objective function, such as a loss function that quantifies loss in terms of cross-entropy or some other loss metric that is suitable for training a machine learning model that is to predict classification score for use in making a classification prediction. However, it is possible that the machine learning process could involve other types of techniques as well.

Further, in practice, the machine learning model that is trained by the model training component 202 may comprise any type of machine learning model that (i) has an input and output of the form described above and (ii) is capable of having its output explained using a model explainability technique. For instance, the machine learning model that is trained by the model training component 202 may comprise a tree-based model (e.g., a standalone decision tree or an ensemble of decision trees that is trained using a gradient boosting technique such as CatBoost, a random forest technique, etc.), a neural-network-based model (e.g., a model based on one or more feed-forward, recurrent, and/or convolution neural networks), a support vector machines (SVM)-based model, a regression-based model, and/or a k-Nearest Neighbor (kNN)-based model, among other possible types of a machine learning model that has an input and output of the form described above and is capable of having its output explained using a model explainability technique.

In accordance with the present disclosure, each training record in the model training dataset may additionally contain or be associated with a respective “subpopulation” value for the respective individual or other entity represented by the training record that identifies a particular subpopulation to which the respective individual or other entity belongs, where that particular subpopulation is selected from a group of distinct subpopulations defined based on one or more protected attributes that give rise to bias concerns. For example, if the machine learning model renders predictions of a given type for individuals from a population comprising both male and female subpopulations—which constitutes a group of two distinct subpopulations that may give rise to bias concerns—then each training record in the model training dataset may contain or be associated with a respective subpopulation value that identifies either the male subpopulation or the female subpopulation as the gender-based subpopulation to which the represented individual belongs. As another example, if the machine learning model renders predictions of a given type for individuals from a population comprising multiple different races—which constitutes a group of multiple distinct subpopulations that may give rise to bias concerns—then each training record in the model training dataset may contain or be associated with a respective subpopulation value that identifies the race-based subpopulation to which the represented individual belongs. Other types of subpopulation values associated with other groups of multiple distinct subpopulations are possible as well, including but not limited to the possibility that the group of distinct subpopulations may be defined based on a combination of multiple different protected attributes (e.g., distinct subpopulations that are defined based on a combination of gender and race). Additionally, depending on the implementation, it is possible that each training record in the model training dataset could contain or be associated with multiple subpopulation values that indicate the represented individual's or entity's membership within multiple different groups of distinct subpopulations that give rise to bias concerns (e.g., a first subpopulation value that identifies a particular gender-based subpopulation from a first group of distinct gender-based subpopulations, a second subpopulation value that identifies a particular race-based subpopulation from a second group of distinct race-based subpopulations, etc.)

However, while the training records that are utilized for training the machine learning model may contain or otherwise be associated with such subpopulation values, it should be understood that these subpopulation values are typically not utilized by the model training component 202 during the training of the machine learning model, nor does the trained machine learning model's input set of features depend on subpopulation values. Rather, such subpopulation values are included because they are utilized by other components of the disclosed software-based pipeline 200 in order to produce a fairer version of the trained machine learning model as described in further detail below—although as with the original version of the trained machine learning model, the fairer version of the trained machine learning model's input set of features will not depend on subpopulation values. In this respect, as with the trained machine learning model, the fairer version of the trained machine learning model that is produced by the disclosed technology will be a “demographically-blind” model.

As one illustrative example of the foregoing functionality, if the model training component 202 is tasked with training a machine learning model for predicting whether individuals from a population comprising multiple distinct subpopulations that give rise to bias concerns are qualified to receive a particular type of service offered by a financial institution (e.g., a financial service such as a loan, a credit card account, a bank account, or the like), the machine learning model's input may comprise an input set of feature variables that are predictive of whether or not the given individual is qualified to receive the particular type of service (e.g., feature variables that provide information related to credit score, credit history, loan history, work history, income, debt, assets, etc.), and the machine learning model's output may comprise a classification score that indicates a predicted likelihood that the given individual is qualified to receive the particular type of service and/or a predicted risk of extending the particular type of service to the given individual—where such classification score may be then compared against a threshold in order to make a classification prediction for the given individual of either a “qualified to receive service” (i.e., the positive outcome) or “not qualified to receive service” (i.e., the negative outcome). And in this representative example, the model training dataset for such a machine learning model may comprise a collection of training records that each contains or is associated with (i) a respective set of feature values for a respective individual that was previously evaluated by the financial institution for purposes of deciding whether to extend the particular type of service to the respective individual, (ii) a respective ground-truth value that indicates whether or not the respective individual was qualified to receive the particular type of service (e.g., a ground-truth value of either 1 if the respective individual was qualified to receive the particular type of service or 0 if the respective individual was not qualified to receive the particular type of service), and (iii) at least one respective subpopulation value that identifies at least one particular subpopulation to which the respective individual belongs (e.g., a value that indicates a particular gender, race, age, sexual orientation, religion, and/or marital status of the respective individual).

The machine learning model that is trained by the model training component 202 and the model training dataset for the machine learning model may take many other forms as well.

The remaining components of the example software-based pipeline 202 may function to produce a fairer version of the trained machine learning model that does not rely on a subpopulation value as part of its input, which as noted above may be referred to herein as a “subpopulation-independent fairer model.”

For instance, the next component of the example software-based pipeline 202 shown in FIG. 2 is the fairer-model initialization component 204, which generally functions to initialize a “target” subpopulation-independent fairer model that is to be approximated or represented by the final version of the subpopulation-independent fairer model that is output by the example software-based pipeline 202 (which will not rely on a subpopulation value).

In accordance with the present disclosure, the target subpopulation-independent fairer model that is initialized by the fairer-model initialization component 204 may comprise a linear combination of (i) the trained machine learning model and (ii) a fairer version of the trained machine learning model that does rely on a subpopulation value as part of its input, which as noted above may be referred to herein as the “subpopulation-dependent fairer model.” Notably, this target subpopulation-independent fairer model does have a term that is dependent on a subpopulation value—specifically, the subpopulation-dependent fairer model—but that term will subsequently be replaced by the fairer-model initialization component 206 in the manner described below in order to eliminate the subpopulation-independent fairer model's dependence on a subpopulation value.

One possible example of such a target subpopulation-independent fairer model for a classification type of machine learning model having a form of f(x)=σ(g(x)) (where g(x) outputs a “raw” value that is then transformed into a probability value by a logistic function) may be represented as follows:

$$\tilde{f} ( x ; θ ) = ( 1 - θ ) \cdot f ( x ) + θ \cdot {\tilde{f}}_{*} ( x , a )$$

where \tilde{f}(x;θ) represents the target subpopulation-independent fairer model, f(x) represents the classification type of machine learning model that is configured to output an unadjusted classification score in the form of a probability value for a set of feature values x, \tilde{f}_{*}(x,a) represents a subpopulation-dependent fairer model for the machine learning model f(x) that is configured to output a fairness-adjusted classification score for the set of feature values x given a subpopulation value a corresponding to the set of feature values x, and θ represents a blending coefficient that defines the relative contribution of the trained machine learning model's output and the subpopulation-dependent fairer model's output to the target subpopulation-independent fairer model's output.

For purposes of illustration, the example software-based pipeline 202 is primarily described below with reference to a classification type of model having the foregoing form, but it should be understood that the software-based pipeline 202 may be utilized to create fairer versions of machine learning models having various other forms as well—including but not limited to a classification type of machine learning model that outputs a classification score in the form of a raw value rather than a probability value or a regressor type of machine learning model that outputs a regressor value (both of which may be represented by g(x) rather than f(x)), among other possibilities.

In the foregoing formulations of the target subpopulation-independent fairer model, the subpopulation value a may take any of various forms. For instance, as one possible implementation, the subpopulation value a may comprise a value selected from a group of subpopulation values that represents a group of distinct subpopulations defined based on a single protected attribute, such as a group of distinct gender-based subpopulations (e.g., a subpopulation value of 0 for a male subpopulation and a subpopulation value of 1 for a female subpopulation, or vice versa), a group of distinct race-based subpopulations, or a group of distinct age-based subpopulations, among other possibilities. In such an implementation, the disclosed functionality for improving fairness (i.e., reducing bias) of the trained machine learning model may then be carried out with respect to that single protected attribute—although improvements in fairness may nevertheless be achieved with respect to other protected attributes as well.

As another possible implementation, the subpopulation value a may comprise a value selected from a group of subpopulation values that represents a group of distinct subpopulations defined based on a combination of multiple protected attributes, such as a group of distinct subpopulations that are defined based on a combination of two or more of gender, race, age, sexual orientation, religion, marital status, etc. For example, in a scenario where the combination of multiple protected attributes constitutes a combination of gender (e.g., male or female) and age (e.g., younger or older), then the group of subpopulation values from which the subpopulation value a is selected may include four values (1) a first subpopulation value for a subpopulation consisting of young males, (2) a second subpopulation value for a subpopulation consisting of older males, (3) a third subpopulation value for a subpopulation consisting of younger females, a (4) fourth subpopulation value for a subpopulation consisting of older females.

As yet another possible implementation, the subpopulation value a may comprise a set of multiple values {a₁, . . . , aₘ}selected from multiple groups of subpopulation values that each represents a respective group of distinct subpopulations defined based on a respective protected attribute, such as a first value selected from a first group of subpopulation values for gender, a second value selected from a second group of subpopulation values for age, and so on.

The subpopulation value a may take other forms as well.

The target subpopulation-independent fairer model that is initialized by the fairer-model initialization component 204 could take various other forms as well, including but not limited to the possibility that the target subpopulation-independent fairer model could include another term in addition to the trained machine learning model and the subpopulation-dependent fairer model (e.g., an intercept constant).

Further, in accordance with the present disclosure, the subpopulation-dependent fairer model that is initialized as part of the target subpopulation-independent fairer model could comprise any predictive model that receives a subpopulation value as part of its input and uses that subpopulation value as a basis for achieving improved fairness in its predicted classification scores relative to the trained machine learning model itself (e.g., by outputting predicted classification scores that satisfy distributional parity across the distinct subpopulations of interest).

For instance, a first possible form of such a subpopulation-dependent fairer model may comprise a predictive model that is configured to (i) provide the set of feature values as input to the trained machine learning model and thereby cause the trained machine learning model to output an initial, unadjusted classification score, and (ii) provide the unadjusted classification score and the subpopulation value as input to a mapping function that utilizes the subpopulation value as a basis for mapping the unadjusted classification score to a fairness-adjusted classification score. In this respect, the mapping function that is utilized by this form of subpopulation-dependent fairer model could take any of various forms.

As one possible implementation, the mapping function may be configured to utilize the subpopulation value as a basis for mapping the unadjusted classification score to a point along a distribution of fairness-adjusted classification scores that constitutes a combination of subpopulation-specific distributions of unadjusted classification scores output by the trained machine learning model for the distinct subpopulations of interest (e.g., a barycenter). To accomplish this, such a mapping function may be configured (i) access a subpopulation-specific cumulative distribution function (CDF) of the subpopulation-specific distribution of unadjusted classification scores output by the trained machine learning model for a given subpopulation represented by the subpopulation value that is provided as input to the subpopulation-dependent fairer model, where that subpopulation-specific CDF indicates the cumulative probabilities corresponding to different unadjusted classification scores for the given subpopulation (e.g., the probabilities of the trained machine learning model's output for the given subpopulation being less than or equal to different unadjusted classification scores), (ii) evaluate the subpopulation-specific CDF at the unadjusted classification score to determine a subpopulation-specific cumulative probability that corresponds to the unadjusted classification score for the given subpopulation, (iii) access a quantile function of the distribution of fairness-adjusted classification scores, where that quantile function indicates the fairness-adjusted classification scores corresponding to different cumulative probabilities (e.g., the fairness-adjusted classification scores at different percentiles within the distribution of fairness-adjusted classification scores), and (iv) evaluate the quantile function of the distribution of fairness-adjusted classification scores at the subpopulation-specific cumulative probability to determine the fairness-adjusted classification score that corresponds to the subpopulation-specific cumulative probability, which is then output by the subpopulation-dependent fairer model as the fairer, fairness-adjusted classification score.

A subpopulation-dependent fairer model that utilizes a mapping function in this form may be represented as:

$${\tilde{f}}_{*} ( x , a ) \to {F}_{B}^{- 1} ( {F}_{a} ( f ( x ) ) ,$$

where \tilde{f}_{*}(x,a) represents the subpopulation-dependent fairer model that is configured to output a fairness-adjusted classification score for a set of feature values x given a subpopulation value a corresponding to the set of feature values x (which as noted above may be selected from a group of subpopulation values representing a group of distinct subpopulations of interest), f(x) represents the trained machine learning model that is configured to output an unadjusted classification score for the set of feature values x, Fₐ(t) represents a subpopulation-specific CDF of the subpopulation-specific distribution of unadjusted classification scores output by the trained machine learning model for the given subpopulation represented by the subpopulation value a, Fₐ(f(x)) represents an operation of evaluating the subpopulation-specific CDF Fₐ(t) at the unadjusted classification score output by the trained machine learning model f(x) to determine a subpopulation-specific cumulative probability corresponding to that unadjusted classification score,

$${F}_{B}^{- 1} ( p )$$

represents a quantile function of a distribution of fairness-adjusted classification scores that constitutes a combination of subpopulation-specific distributions of unadjusted classification scores output by the trained machine learning model for the distinct subpopulations of interest, and

$${F}_{B}^{- 1} ( {F}_{a} ( f ( x ) )$$

represents an operation of evaluating the quantile function

$${F}_{B}^{- 1} ( p )$$

at the subpopulation-specific cumulative probability determined by Fₐ(f(x)) to determine the fairness-adjusted classification score that corresponds to the subpopulation-specific cumulative probability, which is then output as the fairer, fairness-adjusted classification score for the set of feature values x given the subpopulation value a.

In the foregoing implementation, the distribution of fairness-adjusted classification scores that constitutes a combination of subpopulation-specific distributions of unadjusted classification scores output by the trained machine learning model for the distinct subpopulations of interest may comprise a barycenter of the subpopulation-specific distributions, such as a optimal transport barycenter that minimizes a weighted distance or divergence metric (e.g., a p-Wasserstein distance such as 1-Wasserstein or 2-Wasserstein, a Kullback-Leibler divergence, etc.) between (i) a combination of the subpopulation-specific distributions and (ii) the subpopulation-specific distributions themselves. However, it is also possible that the distribution of fairness-adjusted classification scores that constitutes a combination of subpopulation-specific distributions of unadjusted classification scores output by the trained machine learning model for the distinct subpopulations of interest comprise a different type of barycenter or a different type of combination between the subpopulation-specific distributions.

As one particular example, the distribution of fairness-adjusted classification scores that constitutes a combination of subpopulation-specific distributions of unadjusted classification scores output by the trained machine learning model for the distinct subpopulations of interest may be a weighted 2-Wasserstein barycenter of the subpopulation-specific distributions, which may be represented as:

$${μ}_{B} = arg {min}_{μ} {\sum }_{i} {w}_{i} {W}_{2}^{2} ( μ , {μ}_{i} )$$

where μ_{B} represents the weighted 2-Wasserstein barycenter of the distributions of unadjusted classification scores output by the trained machine learning model for the distinct subpopulations of interest, μᵢ represents the subpopulation-specific distribution of unadjusted classification scores output by the trained machine learning model for the i^{th} subpopulation, wᵢ represents a subpopulation-specific weight for the i^{th} subpopulation that defines a relative contribution of the i^{th} subpopulation to the weighted 2-Wasserstein barycenter (where the values of wᵢ add up to a total of 1 across all subpopulations of interest), μ represents a candidate for the weighted 2-Wasserstein barycenter, and

$${W}_{2}^{2} ( μ , {μ}_{i} )$$

represents the 2-Wasserstein distance between the candidate barycenter μ and the subpopulation-specific distribution μᵢ for the i^{th} subpopulation. In this respect, the subpopulation-specific weights may be fixed values that correspond to the subpopulations' respective percentages of the total population of interest (e.g., if a∈{0,1}, then w₀ may represent a first value between 0 and 1 that represents the percentage of the total population of interest that belongs to the first subpopulation represented by a=0 and w₁ may represent a second value between 0 and 1 that represents the percentage of the total population of interest that belongs to the second subpopulation represented by a=1).

Further, in the above example where the distribution of fairness-adjusted classification scores is a weighted 2-Wasserstein barycenter of the subpopulation-specific distributions, the quantile function of the distribution of fairness-adjusted classification scores may be represented as:

$${F}_{B}^{- 1} ( p ) = {\sum }_{i} {w}_{i} \cdot {F}_{i}^{- 1} ( p ) ,$$

where

$${F}_{B}^{- 1} ( p )$$

represents the quantile function of the weighted 2-Wasserstein barycenter (which is the inverse of the CDF F_{B}(t) of the distribution of fairness-adjusted classification scores),

$${F}_{i}^{- 1} ( p )$$

represents a quantile function of the subpopulation-specific of the unadjusted classification scores output by the trained machine learning model for the i^{th} subpopulation (which is the inverse of a CDF Fᵢ(t) of the subpopulation-specific distribution of unadjusted classification scores output by the trained machine learning model for the i^{th} subpopulation), and wᵢ represents the same subpopulation-specific weight for the i^{th} subpopulation that is used to produce the weighted 2-Wasserstein barycenter (where the values of wᵢ add up to a total of 1 across all subpopulations of interest). In other words, in this example, the quantile function of the distribution of fairness-adjusted classification scores may comprise a linear combination of the quantile functions of the subpopulation-specific distributions of unadjusted classification scores output by the trained machine learning model for the subpopulations of interest. Notably, this enables the fairer-model initialization component 204 to define and initialize the quantile function of the weighted 2-Wasserstein barycenter without actually computing the weighted 2-Wasserstein barycenter, which is advantageous because the function of computing the weighted 2-Wasserstein barycenter typically involves an optimization process for solving a minimization problem that tends to be complex, computationally intensive and expensive (e.g., in terms of the extent of compute resources required), and time consuming.

The foregoing formulations of the example subpopulation-dependent fairer model represent the theoretical CDFs and quantile functions of the distributions, but in practice, the mapping function of the subpopulation-dependent fairer model will typically utilize empirical CDFs and quantile functions that are constructed from observed data samples (e.g., the collection of training records). To represent this use of empirical CDFs and quantile functions in place of theoretical CDFs and quantile functions, the foregoing formulations of the example subpopulation-dependent fairer model may be updated as follows:

$${\tilde{f}}_{*} ( x , a ) \to {\hat{F}}_{B}^{[ - 1 ]} ( {\hat{F}}_{a} ( f ( x ) ) : {\hat{F}}_{B}^{[ - 1 ]} ( p ) = {\sum }_{i} {w}_{i} \cdot {\hat{{F}_{i}}}^{[ - 1 ]} ( p ) ,$$

where f(x) represents the trained machine learning model that is configured to output an unadjusted classification score for the set of feature values x,

$${\hat{F}}_{a} ( t )$$

represents an empirical subpopulation-specific CDF of the subpopulation-specific distribution of unadjusted classification scores output by the trained machine learning model for the given subpopulation represented by the subpopulation value a,

$${\hat{F}}_{B}^{[ - 1 ]} ( p )$$

represents an empirical quantile function of the distribution of fairness-adjusted classification scores (which is the generalized inverse of an empirical CDF \hat{F}_{B}(t) of the distribution of fairness-adjusted classification scores),

$${\hat{{F}_{i}}}^{[ - 1 ]} ( p )$$

represents an empirical quantile function of the subpopulation-specific distribution of unadjusted classification scores output by the trained machine learning model for the i^{th} subpopulation (which is the generalized inverse of the empirical subpopulation-specific CDF \hat{F}ᵢ(t) of the subpopulation-specific distribution of the unadjusted classification scores output by the trained machine learning model for the i^{th} subpopulation), and wᵢ represents the same subpopulation-specific weight for the i^{th} subpopulation that is used to produce the weighted 2-Wasserstein barycenter (where the values of wᵢ add up to a total of 1 across all subpopulations of interest).

In such an example where the subpopulation-dependent fairer model comprises a mapping function that uses empirical CDFs and quantile functions, the function of initializing the subpopulation-dependent fairer model may additionally involve pre-constructing and storing the empirical CDFs and quantile functions that are to be utilized by the mapping function of the subpopulation-dependent fairer model. Depending on the form of the subpopulation-dependent fairer model, this function could take any of various forms.

For instance, in the example discussed above, the mapping function of the subpopulation-dependent fairer model is configured to access and evaluate (i) empirical subpopulation-specific CDFs of the subpopulation-specific distributions of unadjusted classification scores output by the trained machine learning model for the distinct subpopulations of interest (represented as \hat{F}ₐ(t) in the above formulation) and (ii) an empirical quantile function of the distribution of fairness-adjusted classification scores that constitutes a combination of the subpopulation-specific distributions of unadjusted classification scores output by the trained machine learning model for the distinct subpopulations of interest (represented as

$${\hat{F}}_{B}^{[ - 1 ]} ( p )$$

in the above formulation). In such an example, the fairer-model initialization component 204 may begin by (i) arranging the collection of training records into subpopulation-specific sub-collections of training records for the distinct subpopulations of interest (e.g., a first sub-collection of training records for a first subpopulation, a second sub-collection of training records for a second subpopulation, etc.) based on the subpopulation values that are contained within (or otherwise associated with) the training records, and then (ii) for each subpopulation-specific sub-collection of training records, utilize the trained machine learning model to predict a respective fairness-adjusted classification score for each training record in the sub-collection (e.g., by inputting the feature values contained within each training record into the trained machine learning model)—which may produce an empirical subpopulation-specific distribution of unadjusted classification scores corresponding to the subpopulation-specific sub-collection of training records.

After producing the empirical subpopulation-specific distributions of unadjusted classification scores for the distinct subpopulations of interest, the fairer-model initialization component 204 may pre-construct the empirical subpopulation-specific CDFs of those empirical subpopulation-specific distributions of unadjusted classification scores for the distinct subpopulations of interest and store them for future use by the mapping function of the subpopulation-dependent fairer model. For each subpopulation of interest, this function may involve (i) determining the cumulative probabilities corresponding to some discrete set of unadjusted classification scores within the empirical subpopulation-specific distribution of unadjusted classification scores for the subpopulation of interest (e.g., unadjusted classification scores at intervals of 0.01 within a range of 0.0 and 1.0), and then (ii) representing the empirical subpopulation-specific CDF in the form of a set of data points that each comprises a respective unadjusted classification score from the discrete set of unadjusted classification scores and the corresponding cumulative probability that was determined for the respective unadjusted classification score (which is sometimes referred to as a “step function”).

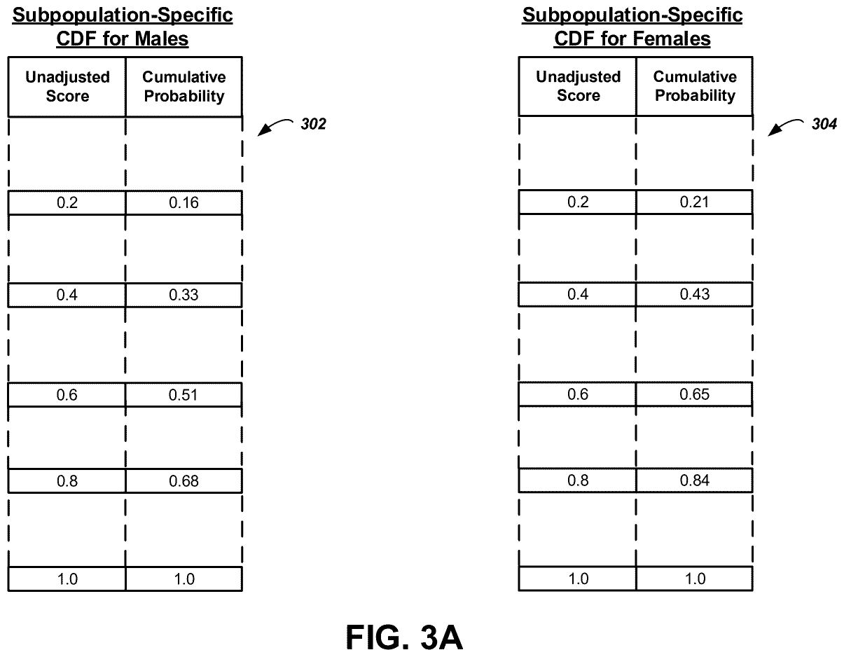

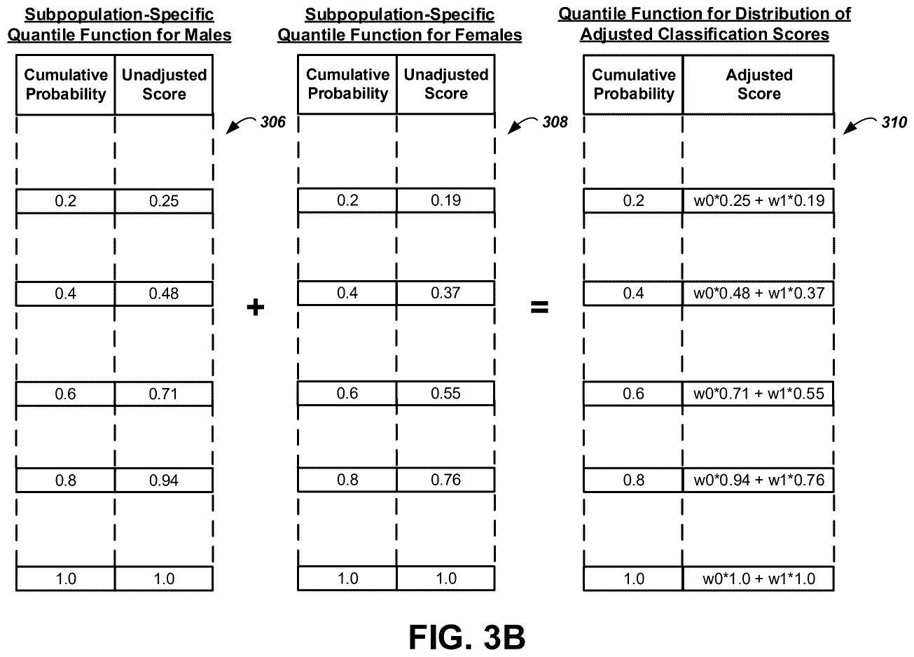

For purposes of illustration, FIG. 3A shows two examples of empirical subpopulation-specific CDFs that may be pre-constructed and stored by the fairer-model initialization component 204, which are (i) a first empirical subpopulation-specific CDF of an empirical subpopulation-specific distribution of unadjusted classification scores for a first subpopulation of males within a population, which is represented in the form of a first set of data points within a first table 302, and (ii) a second empirical subpopulation-specific CDF of an empirical subpopulation-specific distribution of unadjusted classification scores for a second subpopulation of females within a population, which is represented in the form of a second set of data points within a second table 304.

As shown in the first table 302, the empirical subpopulation-specific CDF for males includes (i) a first example data point indicating that 16% of unadjusted classification scores for males are less than or equal to 0.2, (ii) a second example data point indicating that 33% of unadjusted classification scores for males are less than or equal to 0.4, (iii) a third example data point indicating that 51% of unadjusted classification scores for males are less than or equal to 0.6, (iv) a fourth example data point indicating that 68% of unadjusted classification scores for males are less than or equal to 0.8, and (v) a fifth example data point indicating that 100% of unadjusted classification scores for males are less than or equal to 1.0.

Further, as shown in the second table 304, the empirical subpopulation-specific CDF for females includes (i) a first example data point indicating that 21% of unadjusted classification scores for females are less than or equal to 0.2, (ii) a second example data point indicating that 43% of unadjusted classification scores for females are less than or equal to 0.4, (iii) a third example data point indicating that 65% of unadjusted classification scores for females are less than or equal to 0.6, (iv) a fourth example data point indicating that 84% of unadjusted classification scores for females are less than or equal to 0.8, and (v) a fifth example data point indicating that 100% of unadjusted classification scores for females are less than or equal to 1.0.

These examples of empirical subpopulation-specific CDF therefore demonstrate that the unadjusted classification scores output by the trained machine learned model are biased towards males, because there is a larger percentage of unadjusted classification scores for males that are greater than the example reference scores than there is for females.

After producing the empirical subpopulation-specific distributions of unadjusted classification scores for the distinct subpopulations of interest, the fairer-model initialization component 204 may additionally pre-construct the empirical quantile function of the distribution of fairness-adjusted classification scores and store it for future use by the mapping function of the subpopulation-dependent fairer model. In the example discussed above where the quantile function of the distribution of fairness-adjusted classification scores comprises a linear combination of the quantile functions of the subpopulation-specific distributions of unadjusted classification scores output by the trained machine learning model for the subpopulations of interest, this function may involve determining the empirical quantile function of the distribution of fairness-adjusted classification scores from the empirical quantile functions of the subpopulation-specific distributions rather than actually constructing the distribution of fairness-adjusted classification scores and then determining the quantile function for that computed of fairness-adjusted classification scores.

To accomplish this, the fairer-model initialization component 204 may first determine the empirical subpopulation-specific quantile functions of the empirical subpopulation-specific distributions, which may involve, for each given empirical subpopulation-specific distribution: (i) determining unadjusted classification scores within the given empirical subpopulation-specific distribution that correspond to a discrete set of cumulative probabilities (e.g. cumulative probabilities at intervals of 0.01 within a range of 0.0 and 1.0), such as by taking the generalized inverse of the empirical subpopulation-specific CDF of the given empirical subpopulation-specific distributions, and then (ii) representing the empirical subpopulation-specific quantile function of the given empirical subpopulation-specific distribution in the form of a set of data points that each comprises a respective cumulative probability from the discrete set of cumulative probabilities and a corresponding unadjusted classification score within the respective empirical subpopulation-specific distribution that was determined for the respective cumulative probability.

In turn, the fairer-model initialization component 204 may use the empirical subpopulation-specific quantile functions of the empirical subpopulation-specific distributions and the sub-population weights for the subpopulations of interest (represented as wᵢ in the above formulation) to pre-construct the empirical quantile function of the distribution of fairness-adjusted classification scores, which may involve (i) for each respective cumulative probability of a discrete set of cumulative probabilities (e.g. cumulative probabilities at intervals of 0.1 within a range of 0.0 and 1.0), determining a fairness-adjusted classification score that corresponds thereto by taking a linear combination of the unadjusted classification scores returned by the different subpopulation-specific quantile functions for the respective cumulative probability, and then (ii) representing the empirical quantile function of the distribution of fairness-adjusted classification scores in the form of a set of data points that each comprises a respective cumulative probability from the discrete set of cumulative probabilities and a corresponding fairness-adjusted classification score that was determined by taking a linear combination of the unadjusted classification scores returned by the different subpopulation-specific quantile functions for the respective cumulative probability.

For purposes of illustration, FIG. 3B shows an example of an empirical quantile function for a distribution of fairness-adjusted classification scores that is pre-constructed from two examples of empirical subpopulation-specific quantile functions, which are (i) a first empirical subpopulation-specific quantile function of an empirical subpopulation-specific distribution of unadjusted classification scores for a first subpopulation of males within a population, which is represented in the form of a first set of data points within a first table 306, and (ii) a second empirical subpopulation-specific quantile function of an empirical subpopulation-specific distribution of unadjusted classification scores for a second subpopulation of females within a population, which is represented in the form of a second set of data points within a second table 308.

As shown in the first table 306, the empirical subpopulation-specific quantile function for males includes (i) a first example data point indicating that the unadjusted classification score for males at the 20th percentile is 0.25, (ii) a second example data point indicating that the unadjusted classification score for males at the 40th percentile is 0.48, (iii) a third example data point indicating that the unadjusted classification score for males at the 60th percentile is 0.71, (iv) a fourth example data point indicating that the unadjusted classification score for males at the 80th percentile is 0.94, and (v) a fifth example data point indicating that the unadjusted classification score for males at the 100th percentile is 1.0.

Further, as shown in the second table 308, the empirical subpopulation-specific quantile function for females includes (i) a first example data point indicating that the unadjusted classification score for females at the 20th percentile is 0.19, (ii) a second example data point indicating that the unadjusted classification score for females at the 40th percentile is 0.37, (iii) a third example data point indicating that the unadjusted classification score for females at the 60th percentile is 0.55, (iv) a fourth example data point indicating that the unadjusted classification score for females at the 80th percentile is 0.76, and (v) a fifth example data point indicating that the unadjusted classification score for females at the 100th percentile is 1.0.

In line with the functionality above, the fairer-model initialization component 204 may use the empirical subpopulation-specific quantile functions reflected in tables 306, 306 along with sub-population weights of w₀ for the male subpopulation and wᵢ for the female subpopulation to pre-construct the empirical quantile function of the distribution of fairness-adjusted classification scores, which is represented in the form of a third set of data points within a third table 310. As shown in the third table 310, the empirical quantile function of the distribution of fairness-adjusted classification scores includes (i) a first example data point indicating that the fairness-adjusted classification score at the 20th percentile is a linear combination of the unadjusted classification scores for males and females at the 20th percentile (represented as w₀·0.25+w₁·0.19), (ii) a second example data point indicating that the fairness-adjusted classification score at the 40th percentile is a linear combination of the unadjusted classification scores for males and females at the 40th percentile (represented as w₀·0.48+w₁·0.37), (iii) a third example data point indicating that the fairness-adjusted classification score at the 60th percentile is a linear combination of the unadjusted classification scores for males and females at the 60th percentile (represented as w₀·0.71+w₁·0.55), (iv) a fourth example data point indicating that the fairness-adjusted classification score at the 80th percentile is a linear combination of the unadjusted classification scores for males and females at the 80th percentile (represented as w₀ 0.94+w₁·0.76), and (v) a fifth example data point indicating that the fairness-adjusted classification score at the 100th percentile is a linear combination of the unadjusted classification scores for males and females at the 100th percentile (represented as w₀·1.0+wᵢ·1.0).

The function of pre-constructing the empirical quantile function of the distribution of fairness-adjusted classification scores may take other forms as well, including but not limited to the possibility that the fairer-model initialization component 204 may alternatively pre-construct the empirical quantile function of the distribution of fairness-adjusted classification scores by (i) constructing the distribution of fairness-adjusted classification scores from the empirical subpopulation-specific distributions (e.g., by computing the weighted Wassterstein-2 barycenter of the empirical subpopulation-specific distributions), and then (ii) determining the quantile function of the constructed distribution of fairness-adjusted classification scores (e.g., by first determining an empirical CDF of the constructed distribution of fairness-adjusted classification scores and then taking the generalized inverse of the empirical CDF).

Depending on the form of the mapping function, the empirical CDFs and/or quantile functions that are pre-constructed and stored by the fairer-model initialization component 204 could take other forms as well.

A subpopulation-dependent fairer model that is based on a mapping function could take any of various other forms as well, including but not limited to the possibility that the subpopulation-dependent fairer model could utilize a different type of mapping function to map an unadjusted classification score output by the trained machine learning model to a fairness-adjusted classification score, such as a mapping function that maps unadjusted classification scores to a different type of distribution of fairness-adjusted classification scores (e.g., a different type of barycenter), a mapping function that utilizes theoretical CDFs and quantile functions rather than empirical CDFs and quantile functions, etc.

A second possible form of the subpopulation-dependent fairer model may comprise a predictive model that is produced by a carrying out an optimization process for minimizing an objective function that takes the form of a custom loss function comprising (i) an error term that quantifies the error of the subpopulation-dependent fairer model relative to the trained machine learning model, (ii) a bias term that quantifies the bias of the subpopulation-dependent fairer model with respect to certain distinct subpopulations, and (iii) a bias coefficient that is applied to the bias term (which may also be referred to as a fairness-penalization weight). Such an objective function may generally be represented as follows:

$$L = ε + ω \cdot ℬ ,$$

where [symbol] represents the objective function, ξ represents the error term of the objective function that quantifies the error of the subpopulation-dependent fairer model relative to the trained machine learning model, [symbol] represents the bias term of the objective function that quantifies the bias of the subpopulation-dependent fairer model, and ω represents the bias coefficient of the objective function. Each of the terms of the objective function may take any of various forms.

To begin, the error term of the objective function (i.e., the ξ term) may comprise any of various types of functions that quantify the error of the subpopulation-dependent fairer model relative to the trained machine learning model, and one possible example of the error term may take the form of:

$$ε = \frac{1}{n} {\sum }_{i = 1}^{n} {( {s}_{i}^{′} - {s}_{i} )}^{2} ,$$

where

$${s}_{i}^{′}$$

represents the classification score output by the subpopulation-dependent fairer model, sᵢ represents the classification score output by the trained machine learning model, and n represents a number of data records that are evaluated during the optimization process.

The error term of the objective function may take other forms as well.

Further, the bias term of the objective function (i.e., the [symbol] term) may comprise any of various types of functions that quantify the bias of the subpopulation-dependent fairer model with respect to distinct subpopulations, examples of which may include a function for estimating a generalization of a Cramer von Mises distance or a Wasserstein distance between distributions of classification scores output by the subpopulation-dependent fairer model for different subpopulations. In this respect, the bias term may take different forms depending on whether the subpopulation value a that is input to the subpopulation-dependent fairer model constitutes a univariate value selected from a single group of subpopulation values or a multivariate value selected from multiple groups of subpopulation values.

For instance, if the subpopulation value a constitutes a univariate value selected from a single group of subpopulation values, the bias term may be represented as:

$$ℬ = Bias ( \tilde{{f}_{*}} \vert A ) ,$$

where \tilde{f}_{*} represents the subpopulation-dependent fairer model being trained and A represents the single group of the subpopulation values that represent the group of distinct subpopulations for which bias is evaluated.

Alternatively, if the subpopulation value a constitutes a multivariate value selected from multiple groups of subpopulation values, the bias term may be represented as:

$$ℬ = {\sum }_{k = 1}^{m} {w}_{k} \cdot Bias ( \tilde{{f}_{*}} \vert {A}_{k} ) ,$$

where \tilde{f}_{*} represents the subpopulation-dependent fairer model being trained, Ak represents a respective one of m groups of the subpopulation values that represent multiple different groups of distinct subpopulations for which bias is evaluated (e.g., a first group defined based on gender, a second group defined based on age, etc.), and wₖ represents a respective weight that is to be applied to the bias value for the respective one of the m groups of the subpopulation values.

To illustrate with a particular example, the foregoing bias term may have the following form in a scenario where the subpopulation value a constitutes a multivariate value selected from a first group of subpopulation values for gender and a second group of subpopulation values for age:

$$ℬ = {w}_{1} \cdot Bias ( \tilde{{f}_{*}} \vert \{ male , female \} ) + {w}_{2} \cdot Bias ( \tilde{{f}_{*}} \vert \{ younger , older \} ) ,$$

where w₁ and w₂ are fixed weight values that add up to a total of 1 (e.g., value of ½ for each).

The bias term of the objective function may take other forms as well.

Further yet, the bias coefficient of the objective function (i.e., the ω coefficient) may comprise a numeric value selected from a defined set of candidate bias-coefficient values that is applied to the bias term of the objective function in order to adjust the weight of the bias term relative to the error term. This defined set of candidate bias-coefficient values may be represented as:

$$ω ∈ [ {ω}_{1} , {ω}_{2} , … , {ω}_{l} ] ,$$

wherein ω represents the bias-coefficient value and l represents the number of bias-coefficient values included in the defined set of candidate bias-coefficient values.

In this respect, the defined set of candidate bias-coefficient values from which the bias coefficient is selected may take any of various forms, and as some possible examples, the defined set of candidate bias-coefficient values may comprise (i) a set of discrete values ranging from 0 to 1 or (ii) a set of discrete values ranging from a minimum value that corresponds to 0% of the error term and a maximum value that corresponds to 100% of the error term, among other possibilities.

The bias coefficient of the objective function may take other forms as well.

The objective function that is used to produce the subpopulation-dependent fairer model could take various other forms as well, including but not limited to the possibility that the bias term and bias coefficient within the objective function could include multiple bias coefficients that are applied to bias terms for different groups of subpopulations (e.g., a first bias coefficient that is applied to a first bias term for a first group of gender-based subpopulations and a second bias coefficient that is applied to a second bias term for a second group of age-based subpopulations).

Further, the collection of data records that is utilized to evaluate the objective function may comprise any collection of data records that each contain a set of feature values for the trained machine learning model's input set of features along with a corresponding subpopulation value. For instance, as one possibility, the collection of data records could comprise the same collection of training records included in the model training dataset or perhaps some variation thereof (e.g., by excluding certain training records that were included in the model training dataset, including additional data records that were held out of the model training dataset, and/or introducing noise into the model training dataset). However, it is also possible that the collection of data records could comprise some other collection of data records that were not used during training of the machine learning model but nevertheless contain the same types of data.

The subpopulation-dependent fairer model that is initialized as part of the target subpopulation-independent fairer model could take other forms as well.

Likewise, the functionality of the fairer-model initialization component 204 may take other forms as well.

Referring again to FIG. 2, the fairer-model updating component 206 generally functions to update the target subpopulation-independent fairer model that was initialized by the fairer-model initialization component 204 in order to replace the subpopulation-dependent fairer model with a projection thereof that is trained to produce a comparable output (e.g., an approximation of a fairness-adjusted classification score) without relying on a subpopulation value as part of its input, which as noted above may be referred to as a “subpopulation-independent projection” of the subpopulation-dependent fairer model. The functionality that is carried out by the fairer-model updating component 206 may take any of various forms.

In at least some implementations, the fairer-model updating component 206 may begin by generating a projection training dataset for use in training the subpopulation-independent projection of the subpopulation-dependent fairer model. To accomplish this, the fairer-model updating component 206 may first select a collection of data records to utilize as the basis for generating the projection training dataset, which could comprise any collection of data records that each contain a set of feature values for the trained machine learning model's input set of features along with a corresponding subpopulation value. For instance, as one possibility, the selected collection of data records could comprise the same collection of training records included in the model training dataset or perhaps some variation thereof (e.g., by excluding certain training records that were included in the model training dataset, including additional data records that were held out of the model training dataset, and/or introducing noise into the model training dataset). However, it is also possible that the selected collection of data records could comprise some other collection of data records that were not used during training of the machine learning model but nevertheless contain the same types of data.

Then, for each respective data record in the selected collection of data records, the fairer-model updating component 206 may (i) input the set of feature values and the subpopulation value contained within (or otherwise associated with) the respective data record into the subpopulation-dependent fairer model and thereby cause the subpopulation-dependent fairer model to output a respective fairness-adjusted classification score for the respective data record, and (ii) use the respective data record and its respective fairness-adjusted classification score as a basis for generating two new training records corresponding to the respective data record: (a) a first new training record that includes the feature values from the respective data record, a label for a positive classification prediction (e.g., a value of “1”), and a weight that constitutes the respective fairness-adjusted classification score predicted by the subpopulation-dependent fairer model, and (b) a second new training record that includes the feature values from the respective data record, a label for a negative classification prediction (e.g., a value of “0”), and a weight that constitutes a complement of the respective fairness-adjusted classification score predicted by the subpopulation-dependent fairer model (e.g., a value of 1−\tilde{f}_{*}(x,a) for a subpopulation-dependent fairer model \tilde{f}_{*}(x,a) that outputs values between 0.0 and 1.0).

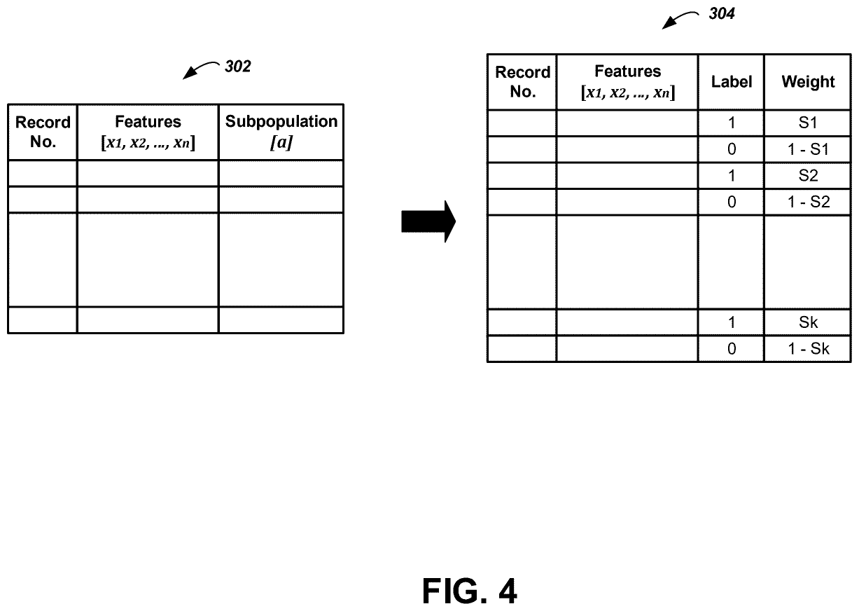

FIG. 4 illustrates one possible example of this function of generating a projection training dataset for use in training the subpopulation-independent projection of the subpopulation-dependent fairer model. In FIG. 4, an example collection of data records that have been selected for use in generating the projection training dataset is shown in a first table 402 that is on the left-hand side of the arrow. In the first table 402, each data record is shown to include a respective set of feature values for an input set of features [x₁, x₂, . . . , xₙ] and a respective subpopulation value for a subpopulation variable a∈{0,1}. For example, a first data record D₁ includes a first set of feature values [x₁(1), x₂(1), . . . , xₙ(1)] and a first subpopulation value a(1), a second data record D₂ includes a second set of feature values [x₁(2), x₂(2), . . . , xₙ(2)] and a second subpopulation value a(2), and so on for each of the other data records in the first table 402. Although not shown in FIG. 4, it is also possible that the data records in the first table 402 could also include other data fields that are not utilized to generate the projection training dataset, such as ground-truth values for classification predictions that were utilized during the training of the machine learning model.

In line with the functionality discussed above, each respective data record in the first table 302 may be input into the subpopulation-dependent fairer model, which may in turn output a respective fairness-adjusted classification score for the respective data record. For example, the subpopulation-dependent fairer model may output a first fairness-adjusted classification score S₁ for the first data record D₁, a second fairness-adjusted classification score S₂ for the second data record D₂, and so on for each of the other data records in the first table 302. In turn, the each respective data record and its respective fairness-adjusted classification score may be utilized to produce two new training data records: (i) a first new training record that includes the respective set of feature values from the respective data record, a label for a positive classification prediction (e.g., a value of “1”), and a weight that constitutes the respective fairness-adjusted classification score for the respective data record, and (ii) a second new training record that includes the respective set of the feature values from the respective data record, a label for a negative classification prediction (e.g., a value of “0”), and a weight that constitutes a complement of the respective fairness-adjusted classification score predicted for the respective data record.

An example collection of new training records that may be produced by this functionality is shown in a second table 404 that on the right-hand side of the arrow. In the second table 404, there are two new training records

$${D}_{k}^{( 1 )} , {D}_{k}^{( 0 )}$$

corresponding to each data record Dₖ in the first table 302, and each such training record is shown to include a respective set of feature values for the input set of features [x₁, x₂, . . . , xₙ], a respective label y∈{0,1}indicating a positive or negative classification prediction, and a respective training weight value. For example, the second table 304 includes two new training records

$${D}_{1}^{( 1 )} , {D}_{1}^{( 0 )}$$

corresponding to the first data record D₁ in the first table 402, where (i) the

$${D}_{1}^{( 1 )}$$

record includes the first set of feature values [x₁(1), x₂(1), . . . , xₙ(1)] from D₁, a label of 1, and a weight value of S₁ (which as noted above is the fairness-adjusted classification score for D₁) and (ii) the

$${D}_{1}^{( 0 )}$$

record includes the first set of feature values [x₁(1), x₂(1), . . . , xₙ(1)] from D₁, a label of 0, and a weight value of (1−S₁). The second table 404 includes a similar pair of new training records corresponding to each of the other data records in the first table 402 as well.

The function of generating the projection training dataset for use in training the subpopulation-independent projection of the subpopulation-dependent fairer model may take various other forms as well.

After generating the projection training dataset for use in training the subpopulation-independent projection of the subpopulation-dependent fairer model, the fairer-model updating component 206 may next train the subpopulation-independent projection by applying a machine learning process to the projection training dataset. In this respect, the machine learning process that is utilized may involve any one or more machine learning techniques that are capable of training a machine learning model based on a training dataset that includes both labels and associated weight values. For instance, as one possibility, the machine learning process may involve a supervised learning technique that functions to train a machine learning model by minimizing a weighted loss function that is well suited for quantifying the loss of a binary classification type of machine learning model, such as a weighted loss function that is based on binary cross-entropy (which may also be referred to as log loss) or hinge loss.

Further, the subpopulation-independent projection that is produced by the machine learning process may comprise any type of machine learning model that (i) has an input and output of the form described above (e.g., feature values for the input set of features as input and a fairness-adjusted classification score as output) and (ii) is capable of having its output explained using a model explainability technique. For instance, the machine learning model that is trained by the model training component 202 may comprise a tree-based model (e.g., a standalone decision tree or an ensemble of decision trees that is trained using a gradient boosting technique such as CatBoost, a random forest technique, etc.), a neural-network-based model (e.g., a model based on one or more feed-forward, recurrent, and/or convolution neural networks), a SVM-based model, a regression-based model, and/or a kNN-based model, among other possible types of a machine learning model that has an input and output of the form described above and is capable of having its output explained using a model explainability technique.

After training the subpopulation-independent projection of the subpopulation-dependent fairer model, the fairer-model updating component 206 may thereafter replace the subpopulation-dependent fairer model that is included in the target subpopulation-independent fairer model with the trained subpopulation-independent projection and thereby produce an updated subpopulation-independent fairer model that comprises a linear combination of (i) the trained machine learning model and (ii) the trained subpopulation-independent projection—where neither term is dependent upon on a subpopulation value. For instance, in the example described above where the subpopulation-independent fairer model for the trained machine learning model f(x) has a form of \tilde{f}(x;θ)=(1−θ)·f(x)+θ·\tilde{f}_{*}(x,a), the subpopulation-dependent fairer model may be replaced with a trained subpopulation-independent projection and the subpopulation-independent fairer model may then be represented as:

$$\tilde{\tilde{f}} ( x ; θ ) = ( 1 - θ ) \cdot f ( x ) + θ \cdot \tilde{\tilde{f}} ( x ) ,$$

where \tilde{\tilde{f}}(x;θ) represents the updated subpopulation-independent fairer model, f(x) represents the trained machine learning model that is configured to output an unadjusted classification score for the set of feature values x, \tilde{\tilde{f}}_{*}(x) represents the trained subpopulation-independent projection that is configured to output a fairness-adjusted classification score for the set of feature values x that approximates what the subpopulation-dependent fairer model would have output as a fairness-adjusted classification score for the set of feature values x given a subpopulation value a corresponding to the set of feature values x, and θ represents a blending coefficient that defines the relative contributions of the trained machine learning model's output and the subpopulation-independent projection's output to the subpopulation-independent fairer model's output.

As with the target subpopulation-independent fairer model that is initialized by the fairer-model initialization component 204, the updated subpopulation-independent fairer model that results from replacing the subpopulation-dependent fairer model with the trained subpopulation-independent projection could take other forms as well.

Further, the functionality of the fairer-model updating component 206 may take other forms as well.

Referring yet again to FIG. 2, the fairer-model selection component 208 generally functions to (i) produce multiple different candidate instances of the updated subpopulation-independent fairer model that weight the relative contributions of the trained machine learning model's output and the subpopulation-independent projection's output differently and (ii) select a given candidate instance of the updated subpopulation-independent fairer model as the version of the updated subpopulation-independent fairer model that is to be deployed, which as noted above may be referred to herein as the “final fairer model.” This functionality may take any of various forms.

In at least some implementations, the fairer-model selection component 208 may begin by producing the multiple different candidate instances of the updated subpopulation-independent fairer model, which may involve creating different versions of the updated subpopulation-independent fairer model that have different values of the blending coefficient θ that defines the relative contributions of the trained machine learning model's output and the subpopulation-independent projection's output to the updated subpopulation-independent fairer model's output. In this respect, each different value of the blending coefficient θ that is inserted into the updated subpopulation-independent fairer model may produce a different candidate instance of the updated subpopulation-independent fairer model that weights the relative contributions of the trained machine learning model's output and the subpopulation-independent projection's output in a different way. For example, (i) inserting a value of the blending coefficient θ that is closer to 1 will produce a candidate instance of the updated subpopulation-independent fairer model that weights the subpopulation-independent projection's output more heavily than the trained machine learning model's output, (ii) inserting a value of the blending coefficient θ that is closer to 0 will produce a candidate instance of the updated subpopulation-independent fairer model that weights the trained machine learning model's output more heavily than the subpopulation-independent projection's output, and (iii) inserting a value of the blending coefficient θ that is closer to 0.5 will produce a candidate instance of the updated subpopulation-independent fairer model that weights the trained machine learning model's output and the subpopulation-independent projection's output and a more even way, among other possibilities.

Depending on the form of the updated subpopulation-independent fairer model, the function of producing the multiple different candidate instances of the updated subpopulation-independent fairer model may take other forms as well.

After producing the multiple different instances of the updated subpopulation-independent fairer model, the fairer-model selection component 208 may next determine a respective pair of performance and bias values for each respective candidate instance of the updated subpopulation-independent fairer model. In this respect, the performance and bias values that are determined for each respective candidate instance of the updated subpopulation-independent fairer model may take any of various forms. To illustrate with some representative examples, the performance value could comprise a metric based on mean-squared loss, cross-entropy loss (e.g., a negative expected value of the cross-entropy loss), exponential loss, or top-capture rate (e.g., a top-capture rate 50), and the bias value could comprise a metric based on a generalization of Cramer von Mises distance or Wasserstein distance between subpopulation-specific distributions of predictions (e.g., a CM₁, CM₂, Wassertein-1 or Wassstein-2 distance), adverse impact ratio (AIR) (e.g., a LOG-AIR or AIR50 metric), or Kolmogorov-Smirnov, among other possible examples of performance and bias values that may be determined for each respective candidate instance of the updated subpopulation-independent fairer model.

Further, the bias value for each respective candidate instance of the updated subpopulation-independent fairer model may be determined with respect to the same group of distinct subpopulations of interest that were to be evaluated by the subpopulation-dependent fairer model, or a different group of distinct subpopulations.

Further yet, in practice, the performance and bias values for each respective candidate instance of the updated subpopulation-independent fairer model may be determined utilizing a collection of data records that each contains feature values for the input set of feature variables and a corresponding ground-truth value for the at least one classification score to be predicted by the trained machine learning model, the classification prediction that is to be made based on the at least one classification score to be predicted, or both. In this respect, the collection of data records could comprise training records from the training dataset or “test” records that were split from the training records prior to the training of the machine learning model, among other possibilities.

Still further, depending on the type of performance and bias values being determined, the function of determining the performance and bias values utilizing such a collection of data records could involve either evaluating the classifications scores themselves (e.g., for performance metrics such as mean-squared loss, cross-entropy loss, and exponential loss and bias metrics such as CM₁, CM₂, Wassertein-1, Wassstein-2, and KS distance) or comparing the classification scores to a threshold in order to produce classification predictions and then evaluating the classification predictions (e.g., for performance metrics such as top capture rate and bias metrics such as AIR), among other possibilities.

The function of determining the respective pair of performance and bias values for each respective candidate instance of the updated subpopulation-independent fairer model may take other forms as well.

After determining the respective pairs of performance and bias values for the respective candidate instances of the updated subpopulation-independent fairer model, the fairer-model selection component 208 may then (i) construct an “efficient frontier” (or sometimes referred to as the “Pareto frontier”) of the tradeoff between performance and bias produced by the updated subpopulation-independent fairer model based on the respective pairs of performance and bias values (e.g. by constructing a convex hull on the performance-bias plane) and (ii) select a given candidate instance of the updated subpopulation-independent fairer model from the efficient frontier (e.g., a candidate instance of the updated subpopulation-independent fairer model having a given candidate value of the blending coefficient θ) by applying certain selection logic to the efficient frontier.

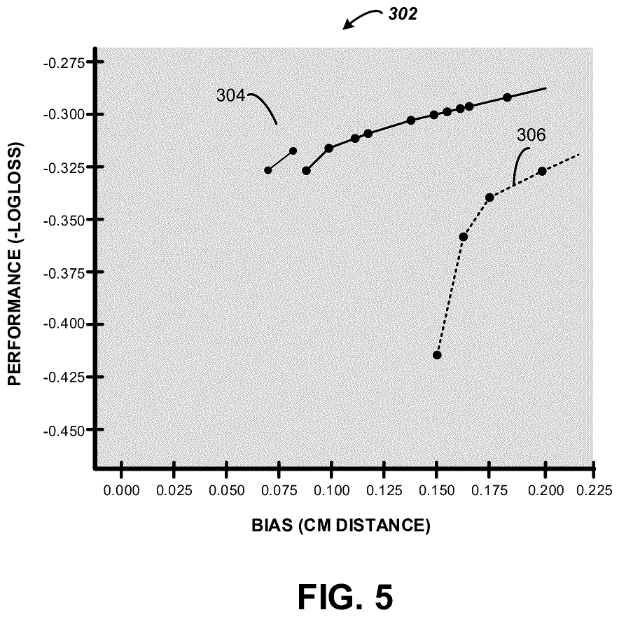

To illustrate with an example, FIG. 5 shows a two-dimensional space 502 of the performance and bias values that may be determined for different fairer-model options, where the x-axis represents bias values that are based on a Cramer von Mises distance and the y-axis represents performance values that are based on cross-entropy loss (e.g., −logloss values). Within this two-dimensional space 502, a first curve 504 is shown for an updated subpopulation-independent fairer model that has been created in accordance with the disclosed technology, where the first curve 504 runs through points representing respective pairs of performance and bias values that are determined for respective candidate instances of the updated subpopulation-independent fairer model (e.g., versions of the subpopulation-independent fairer model having different values of the blending coefficient θ). In this respect, the first curve 504 may represent the efficient frontier that is constructed for the updated subpopulation-independent fairer model. Additionally, within this two-dimensional space 502, a second curve 506 is shown for a fairer model that has been created in accordance with previously-existing technology, where the second curve 506 runs through points representing respective pairs of performance and bias values that are determined for respective candidate instances of the fairer model created in accordance with previously-existing technology.

As can been seen in FIG. 5, the disclosed technology achieves significant improvements over the previously-existing technology with respect to the performance and bias values of the fairer model. In particular, at the same level of performance, the candidate instances of the updated subpopulation-independent fairer model exhibit significantly less bias than the candidate instances of the fairer model created in accordance with previously-existing technology, and similarly, at the same level of bias, the candidate instances of the updated subpopulation-independent fairer model exhibit significantly better performance than the candidate instances of the fairer model created in accordance with previously-existing technology.

The performance and bias values that are determined for the candidate instances of the updated subpopulation-independent fairer model produced by the disclosed technology may take various other forms as well.

Further, the selection logic that is utilized to select the given candidate instance of the updated subpopulation-independent fairer model from the efficient frontier may take any of various forms. For instance, as one possibility, the selection logic may encode a threshold level of acceptable bias for the fairer model and define a selection process whereby the fairer-model selection component 208 limits its analysis to candidate instances of the updated subpopulation-independent fairer model along the efficient frontier that do not exceed the threshold level of acceptable bias and selects whichever of those candidate instances has the best performance. For example, the fairer-model selection component 208 may be configured to identify whichever candidate instance of the updated subpopulation-independent fairer model along the efficient frontier has a bias value that is closest to the threshold level of acceptable bias without exceeding it, as that is expected to be the candidate instance of the updated subpopulation-independent fairer model below the threshold level of bias that has the best performance.

As another possibility, the selection logic may encode a threshold level of acceptable performance of the fairer model and define a selection process whereby the fairer-model selection component 208 limits its analysis to candidate instances of the updated subpopulation-independent fairer model along the efficient frontier that do not fall below the threshold level of acceptable performance and selects whichever of those candidate instances has the least bias. For example, the fairer-model selection component 208 may be configured to identify whichever candidate instance of the updated subpopulation-independent fairer model along the efficient frontier has a performance that is closest to the threshold level of acceptable performance without falling below it, as that is expected to be the candidate instance of the updated subpopulation-independent fairer model above the threshold level of performance that has the least bias.

The selection logic that is applied by the fairer-model selection component 208 in order to select the given candidate instance of the updated subpopulation-independent fairer model may take various other forms as well, including but not limited to the possibility that the selection logic may utilize different types of performance and/or bias metrics as the basis for selecting the given candidate instance of the updated subpopulation-independent fairer model and/or that the selection logic may evaluate other factors in addition to bias and performance.

The functionality of the fairer-model selection component 208 may take other forms as well.

After the given candidate instance of the updated subpopulation-independent fairer model is selected by the perturbed-model selection component 208, that given candidate instance of the updated subpopulation-independent fairer model may be output by the example software-based pipeline 200 as the final fairer model that is be utilized in place of the original version of the trained machine learning model in order to achieve improved fairness relative to the original version of the trained machine learning model while still maintaining an acceptable level of performance. As one possible example, the given candidate instance of the updated subpopulation-independent fairer model that is output by the example software-based pipeline 200 as the final fairer model may be represented as:

$$\tilde{\tilde{f}} ( x ; {θ}_{*} ) = ( 1 - {θ}_{*} ) \cdot f ( x ) + {θ}_{*} \cdot {\tilde{\tilde{f}}}_{*} ( x ) ,$$

where \tilde{\tilde{f}}(x;θ_{*}) represents the final fairer model, f(x) represents the trained machine learning model that is configured to output an unadjusted classification score for the set of feature values x, \tilde{\tilde{f}}(x) represents the trained subpopulation-independent projection that is configured to output a fairness-adjusted classification score for the set of feature values x that approximates what the subpopulation-dependent fairer model would have output as a fairness-adjusted classification score for the set of feature values x given a subpopulation value a corresponding to the set of feature values x, and θ_{*} represents a particular blending coefficient that defines the relative contributions of the trained machine learning model's output and the subpopulation-independent projection's output to the fairer model's output (where that particular blending coefficient is selected based on some selection criteria related to performance and bias).

In turn, the final fairer model that is output by the example software-based pipeline 200 may then be deployed for execution by the computing platform 102 and/or some other computing platform, and may thereafter be utilized to render predictions of the given type for individuals or other entities from a population comprising distinct subpopulations that give rise to bias concerns (e.g., subpopulations defined based on gender, race, age, sexual orientation, religion, marital status, etc.). For instance, the computing platform 102 and/or some other computing platform may begin executing the final fairer model by providing it with input records for individuals or other entities from a population comprising distinct subpopulations that give rise to bias concerns and thereby causing it to render predictions of the given type for such individuals or other entities.

As one possible example to illustrate, the final fairer model may function to render predictions of whether individuals (or other entities) from a population comprising multiple distinct subpopulations that give rise to bias concerns are qualified to receive a particular type of service offered by a financial institution (e.g., a financial service such as a loan, a credit card account, a bank account, or the like) by outputting classification scores for such individuals that are then compared against a threshold in order to make classification predictions for the individuals of either a “qualified to receive service” (i.e., the positive outcome) or “not qualified to receive service” (i.e., the negative outcome).

The final fairer model may be configured to render predictions of various other types as well.

Further, in practice, the functionality for executing the final fairer model that is produced by the software-based pipeline 200 in order to render a prediction for a given input record comprising a set of feature values for the trained machine learning model's input set of features may involve providing the set of feature values as input to the final fairer model and thereby causing the final fairer model to predict and output a given fairer classification score for the given input record. In this respect, in line with the discussion above, the final function final fairer model may function to predict the fairer classification score for the given input record may involve (i) utilizing the trained machine learning model to predict a first base classification score for the given input record (e.g., by inputting the given input record's set of feature values into the trained machine learning model), (ii) utilizing the subpopulation-independent projection to predict a second base classification score for the given input record (e.g., by inputting the given input record's set of feature values into the subpopulation-independent projection), and (iii) combining the first base classification score output by the trained machine learning model and the second base classification score output by the subpopulation-independent projection into the fairer classification score for the given input record that is then output by the final fairer model.

The functionality for executing the fairer version of the trained machine learning model may take various other forms as well.

In line with the discussion above, the final fairer model that is produced by the example software-based pipeline 200 may also be explainable, in that the final fairer model is capable of having its predictions explained in terms of explanation values that quantify the contributions of the input set of features to the predictions output by the final fairer model.

In accordance with the present disclosure, the explanation values for a given classification score that is output by the final fairer model for a given input record may be determined based on (i) a first set of explanation values that explain that quantify the contributions of the input set of features to the first base classification score output by the trained machine learning model for the given input record and (ii) a second set of explanation values that explain that quantify the contributions of the input set of features to the second base classification score output by the subpopulation-independent projection for the given input record. For instance, in a scenario where the fairer version of the trained machine learning model takes the form of \tilde{\tilde{f}}(x;θ_{*})=(1−θ_{*})·f(x)+θ_{*}·\tilde{\tilde{f}}(x) as in the representative example described above, the explanation values for a fairer classification score that is output by the final fairer model for an input record may be determined using the following vector-function:

$$h ( x ; \tilde{\tilde{f}} ) = ( 1 - {θ}_{*} ) \cdot h ( x ; f ) + {θ}_{*} \cdot h ( x ; {\tilde{\tilde{f}}}_{*} ) ,$$

where

$$h ( x ; \tilde{\tilde{f}} ) = {\{ {h}_{i} ( x ; \tilde{\tilde{f}} ) \}}_{i = 1}^{n}$$

represents a set of explanation values for a given classification score that is output by the fairer model \tilde{\tilde{f}}(x;α_{*}) for a given input record comprising a set of feature values x for the input set of features of the original model f(x), h(x;f) represents a first set of explanation values for a first base classification score that is output by the original model f(x) for the given set of feature values x, h (x;\tilde{\tilde{f}}_{*}) represents a second set of explanation values for a second base classification score that is output by the subpopulation-independent projection \tilde{\tilde{f}}_{*}(x) for the given set of feature values x, and θ_{*} represents the blending coefficient that defines the relative contributions of the trained machine learning model's output and the subpopulation-independent projection's output to the fairer model's output.

In the forgoing formulation, the first and second sets of explanation values may comprise explanation values that are determined utilizing any type of model explainability technique that is capable of producing additive explanations. One possible type of such a model explainability technique may comprise a game-theoretic explainability technique for determining or approximating marginal or conditional game values that are additive, such as Shapley values, Owen values, or Banzhaf-Owen values, and some representative examples of such a game-theoretic explainability technique include the model-agnostic Shapley Additive Explanation (SHAP) technique and the family of model-specific variants of SHAP, such as TreeSHAP (e.g., path-dependent or interventional TreeSHAP), KernelSHAP, or LinearSHAP, among others. However, other possible types of model explainability techniques could be utilized to determine the first and second sets of explanation values as well, including but not limited to a Local Interpretable Model-agnostic Explanations (LIME) technique or a plot-based explanation technique (e.g., Partial Dependence Plots (PDP), Individual Conditional Expectation (ICE) plots, Accumulated Local Effects (ALE), etc.), among others.

Further, in practice, the computing platform 102 (and/or some other computing platform) may determine the first and second sets of explanation values by either (i) utilizing the model explainability technique to evaluate the contributions of the input set of features to the two base classification scores that are produced by the trained machine learning model and the subpopulation-independent projection during execution of the final fairer model, or (ii) accessing pre-determined sets of explanation values for data records that are comparable to the given input record (e.g., data records comprising comparable sets of feature values), such as sets of explanation values that have been pre-determined for the training records that were utilized to train the machine learning model and/or the subpopulation-independent projection, and then using the pre-determined sets of explanation values for the comparable data records as a basis for determining the first and second sets of explanation values for the given input record (e.g., by applying a technique for determining an unknown value from other known values, such as interpolation, kNN imputation, or the like).

The functionality for explaining the predictions output by the final fairer model may take other forms as well.

Certain variations and/or extensions of the pipeline functionality described above may also be possible.

For instance, as one possible variation and/or extension of the pipeline functionality described above, the sequence of operations that are carried out by the software-based pipeline 200 in order to produce the fairer version of the trained machine learning model may be modified such that the software-based pipeline 200 initializes a subpopulation-dependent fairer model and trains a subpopulation-independent projection of the subpopulation-dependent fairer model prior to initializing the subpopulation-independent fairer model that forms the basis for the final version of the fairer model. In other words, instead of starting out by initializing a target subpopulation-independent fairer model that includes a subpopulation-dependent fairer model as one of its terms, the software-based pipeline 200 may function to (i) initialize a subpopulation-dependent fairer model having a form that is similar to that described above, (ii) train a subpopulation-independent projection of the subpopulation-dependent fairer model in a manner that is similar to that described above, and then (iii) initialize a subpopulation-independent fairer model that comprises a linear combination of the trained machine learning model and the subpopulation-dependent projection of the subpopulation-dependent fairer model, after which time the software-based pipeline 200 may select a given instance of the subpopulation-independent fairer model as the fairer version of the trained machine learning model to utilize in place of the original version of the trained machine learning model.

As another possible variation and/or extension of the pipeline functionality described above, the trained machine learning model for which the fairer model is produced may comprise a “multi-class” machine learning model that is configured to output multiple classification scores for multiple different outcomes that are then used to make a classification prediction between the multiple different outcomes. In this respect, each of the trained machine learning model itself, the subpopulation-dependent fairer model, the subpopulation-dependent projection of the subpopulation-dependent fairer model, and the subpopulation-independent fairer model may have an output that comprises a vector of multiple classification scores corresponding to the different possible outcomes—which may also be thought of as a point in a multi-dimensional space in which the dimensions correspond to the different possible outcomes.

In such an implementation, the functionality that is carried out by the software-based pipeline 200 may be similar to that described above, except that the formulations and operations related to the classification scores may be in multiple dimensions rather than in a single dimension. For example, in the formulations of the subpopulation-independent fairer model discussed above, the linear combination of the unadjusted classification score output by the trained machine learning model and the subpopulation-dependent projection of the subpopulation-dependent fairer model may take place in multiple dimensions (and utilize multiple blending coefficients that correspond to the different dimensions) rather than in a single dimension. As another example, in the formulations of the subpopulation-dependent fairer model discussed above, the distributions and corresponding CDFs and quantile functions that are utilized by the mapping function may comprise multi-dimensional distributions and corresponding multi-dimensional CDFs and quantile functions, and if the combination of subpopulation-specific distributions of unadjusted classification scores comprises a barycenter (e.g., weighted 2-Wasserstein barycenter), the initialization component 204 may be required to compute the barycenter by carrying out an optimization process for solving a minimization problem prior to determining the multi-dimensional CDFs and quantile functions. As yet another example, when generating the projection training dataset for training the subpopulation-dependent projection of the subpopulation-dependent fairer model, each respective data record in the selected collection of data records may be utilized as a basis for creating a respective set of multiple training records corresponding to the different possible outcomes that may be predicted by the multi-class classification type of machine learning model, where each training record in the respective set contains a label for a given one of the different possible outcomes and a weight that comprises a classification score output by the subpopulation-dependent fairer model for the given outcome. As still another example, when training the subpopulation-dependent projection of the subpopulation-dependent fairer model, the machine learning process may utilize a weighted loss function that is well suited for quantifying the loss of a multi-class classification type of machine learning model, such as a weighted loss function that is based on categorical cross-entropy.

When utilizing the functionality of the software-based pipeline 200 to produce a fairer version of a multi-class classification type of machine learning model, such functionality could be modified in other ways as well, including but not limited to the possibility that the fairer-model selection component 208 could also utilize different performance and/or bias metrics that are better suited for quantifying the performance and/or bias of a multi-class classification type of machine learning model.

As yet another possible variation and/or extension of the pipeline functionality described above, the trained machine learning model for which the fairer model is produced may comprise a “regression” type of machine learning model that is configured to output a predicted value from a continuous numerical variable that represents something other than a classification score. In this respect, each of the trained machine learning model itself, the subpopulation-dependent fairer model, the subpopulation-dependent projection of the subpopulation-dependent fairer model, and the subpopulation-independent fairer model may have an output that comprises a predicted value of the continuous numerical variable (rather than a classification score).

In such an implementation, the functionality that is carried out by the software-based pipeline 200 may be similar to that described above, except that the formulations and operations related to the classification scores may instead involve predicted values of a continuous numerical variable. For example, in the formulations of the subpopulation-independent fairer model discussed above, the linear combination of the trained machine learning model and the subpopulation-dependent projection of the subpopulation-dependent fairer model may comprise a linear combination of predicted values of the continuous numerical variable (rather than classification scores). As another example, in the formulations of the subpopulation-dependent fairer model discussed above, the distributions and corresponding CDFs and quantile functions that are utilized by the mapping function may comprise distributions and corresponding CDFs and quantile functions for predicted values of the continuous numerical variable (rather than classification scores). As yet another example, when generating the projection training dataset for training the subpopulation-dependent projection of the subpopulation-dependent fairer model, each respective data record in the selected collection of data records may be utilized as a basis for creating a single corresponding training record that contains the predicted value of the continuous numerical variable that is output by the subpopulation-dependent fairer model as the label without any corresponding weigh value. As still another example, when training the subpopulation-dependent projection of the subpopulation-dependent fairer model, the machine learning process may utilize an unweighted loss function (rather than a weighted loss function) that is well suited for quantifying the loss of a regression type of machine learning model, such as a unweighted loss function that is based on mean square error (MSE) or mean absolute error (MAE).

When utilizing the functionality of the software-based pipeline 200 to produce a fairer version of a regression type of machine learning model, such functionality could be modified in other ways as well, including but not limited to the possibility that the fairer-model selection component 208 could also utilize different performance and/or bias metrics that are better suited for quantifying the performance and/or bias of a regression type of machine learning model.

As still another possible variation and/or extension of the pipeline functionality described above, the example software-based pipeline 200 could be utilized to produce multiple different fairer versions of a trained machine learning model that can then be combined into an ensemble model. For instance, the functionality of the example software-based pipeline 200 could be repeated multiple times in order to produce multiple fairer versions of the trained machine learning model that each serve to improve fairness with respect to a different protected attribute, such as a first fairer version of the trained machine learning model that improves fairness with respect to a first protected attribute (e.g., gender), a second fairer version of the trained machine learning model that improves fairness with respect to a second protected attribute (e.g., race), and so on, and the multiple fairer versions of the trained machine learning model could then be combined together into an ensemble model. In this respect, the function of producing the ensemble model may take any of various forms, and in at least some implementations, may involve (i) arranging the multiple fairer versions of the trained machine learning model into a linear combination in which each respective fairer version has a corresponding fairer-model weight, (ii) varying the fairer-model weights in order to produce multiple different candidate instances of the ensemble model, (iii) evaluating the performance and bias of the multiple different candidate instances of the ensemble model (e.g., in a similar manner to how the performance and bias of the multiple different instances of the subpopulation-independent fairer model is evaluated), and (iv) based on the evaluation, selecting a given instance of the ensemble model to utilize as the final ensemble model.

In practice, the foregoing extension could be utilized in a scenario where the example software-based pipeline 200 is designed to produce a fairer version of a trained machine learning model with respect to a single protected attribute rather than a combination of multiple protected attributes, but there is nevertheless a desire to improve the trained machine learning model's fairness with respect to multiple different attributes. However, this scenario could alternatively be addressed by the fairer-model selection component 208 during the process of selecting which instance of the subpopulation-independent fairer model to utilize as the fairer version of the trained machine model. For instance, even if the target subpopulation-independent fairer model is designed to improve fairness with respect to a single protected attribute, the fairer-model selection component 208 may utilize a bias metric and associated selection criteria that assesses bias across multiple different protected attributes when selecting which instance of the subpopulation-independent fairer model to utilize as the fairer version of the trained machine model.

As a further possible variation and/or extension of the pipeline functionality described above, in a scenario where the trained machine learning model is a classification type of model that outputs a raw value or a regressor type of model, each of which may be represented as g(x), then (i) the target subpopulation independent model described above may be rewritten in the form of \tilde{g}(x;θ)=g(x)+θ·(\tilde{g}_{*}(x,a)−g(x)) and (ii) the entire term (\tilde{g}_{*}(x,a)−g(x)) may be replaced by an explainable “residual” model. More particularly, the software-based pipeline 200 may first define a “subpopulation dependent residual model” function having a form of:

$$δ ( x , a ) = ( {\tilde{g}}_{*} ( x , a ) - g ( x ) ) ,$$

where δ represents the difference between the subpopulation-dependent fairer model and the trained machine learning model.

In turn, the software-based pipeline 200 may train a “subpopulation-dependent residual model projection” having a form of:

$$\tilde{δ} ( x ) = 𝔼 [ δ ( X , A ) \vert X = x ] .$$

In practice, training this subpopulation-dependent residual model projection may involve fitting a “regressor” using a regression machine learning model with an error being standard mean square error.

This variation may be beneficial in scenarios where the trained machine learning model is substantially the same as the subpopulation-dependent fairer model, as it may reduce the time and resources required to train the projection.

Other variations and/or extensions of the pipeline functionality described above may be possible as well.

Further, the example software-based pipeline 200 described above could take other forms. For instance, as one possibility, the example software-based pipeline 200 may include other components that are not shown or described above but may nevertheless facilitate the functionality disclosed herein. As another possibility, certain of the components shown and described above could be combined together or separated out into multiple sub-components. As yet another possibility, certain of the components shown and described above may perform additional or different functionality from what is described above. Other variations of the example software-based pipeline 200 are possible as well.

Further yet, as noted above, it is possible that the components of the example software-based pipeline 200 could be distributed across multiple different computing platforms. For instance, as one possibility, model training component 202 could be hosted on a separate computing platform from the rest of the components of the example software-based pipeline 200 (e.g., in a scenario where the machine learning model is trained by one organization and then provided to a different organization that is tasked with creating the fairer version of the trained machine learning model). As another possibility, the component(s) that execute the fairer version of the trained machine learning model and generate explanations for the fairer version of the trained machine learning model could be hosted on a separate computing platform from the rest of the components of the example software-based pipeline 200 (e.g., in a scenario where the fairer version of the trained machine learning model is created by one organization and then provided to a different organization that is tasked with executing the fairer version of the trained machine learning model and generating explanations therefor). Other arrangements of the components of the example software-based pipeline 200 are possible as well.

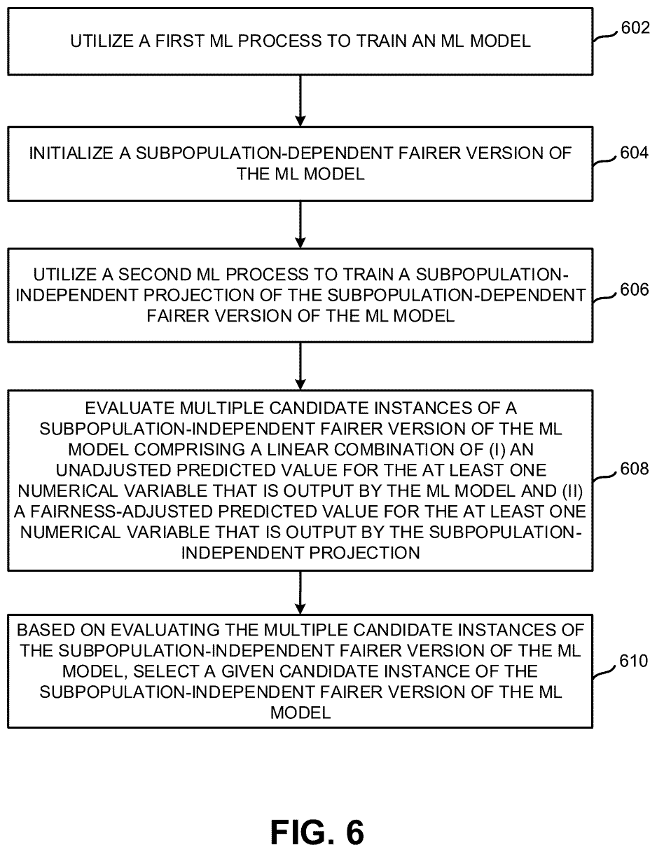

One possible example of functionality 600 that may be carried out in accordance with the disclosed technology will now be described with reference to the flow chart of FIG. 6. In practice, the functionality 600 of FIG. 6 may be encoded in the form of program instructions that are executable by one or more processors of a computing platform, and for purposes of illustration, the functionality 600 of FIG. 6 is described as being carried out by the computing platform 102 of FIG. 1, but it should be understood that the functionality 600 of FIG. 6 may be carried out by any one or more computing platforms that are capable of being installed with software for performing the functions described below. Further, it should be understood that the functionality 600 of FIG. 6 is merely described in this manner for the sake of clarity and explanation and that the example may be implemented in various other manners, including the possibility that functions may be added, removed, rearranged into different orders, combined into fewer blocks, and/or separated into additional blocks depending upon the particular example.

As shown in FIG. 6, the functionality 600 may begin at block 602 with the back-end computing platform 102 utilize a first machine learning process to train a machine learning model that is configured to (i) receive an input record comprising feature values for an input set of features and (ii) output an unadjusted predicted value for at least one numerical variable. In this respect, the first machine learning process, the machine learning model, the input set of features, and the at least one numerical variable may take any of various forms, including but not limited to any of the various forms described above.

At block 604, the back-end computing platform 102 may initialize a subpopulation-dependent fairer version of the trained machine learning model that is configured to (i) receive an input record comprising feature values for the input set of features and a subpopulation value indicating that the input record is associated with a particular subpopulation from a group of distinct subpopulations and (ii) output a fairness-adjusted predicted value for the at least one numerical variable that is dependent on the subpopulation value. In this respect, the subpopulation-dependent fairer version of the trained machine learning model may take any of various forms, including but not limited to any of the various forms described above. Further, in practice, the function of initializing the subpopulation-dependent fairer version of the trained machine learning model may be carried out based on configuration information for the subpopulation-dependent fairer version of the trained machine learning model that is provided as input to the functionality 600, among other possibilities. For instance, the back-end computing platform 102 may function to receive configuration information for the subpopulation-dependent fairer version of the trained machine learning model (e.g., configuration information that is specified by a user and/or contained within a definition file that is created by some other software component) and then initialize the subpopulation-dependent fairer version of the trained machine learning model based on that received configuration information.

At block 606, the back-end computing platform 102 may utilize a second machine learning process to train a subpopulation-independent projection of the subpopulation-dependent fairer version of the trained machine learning model that is configured to (i) receive an input record comprising feature values for the input set of features and (ii) output a fairness-adjusted predicted value for the at least one numerical variable without relying on any subpopulation value. In this respect, the second machine learning process and the subpopulation-independent projection of the subpopulation-dependent fairer version of the trained machine learning model may take any of various forms, including but not limited to any of the various forms described above.

At block 608, the back-end computing platform 102 may evaluate multiple candidate instances of a subpopulation-independent fairer version of the trained machine learning model comprising a linear combination of (i) an unadjusted predicted value for the at least one numerical variable that is output by the trained machine learning model and (ii) a fairness-adjusted predicted value for the at least one numerical variable that is output by the subpopulation-independent projection, where each respective candidate instance of the subpopulation-independent fairer version of the trained machine learning model applies a different weighting to the unadjusted and fairness-adjusted predicted values within the linear combination. In this respect, the function of evaluating the multiple candidate instances of a subpopulation-independent fairer version of the trained machine learning model may take any of various forms, including but not limited to any of the various forms described above.

At block 610, based on evaluating the multiple candidate instances of the subpopulation-independent fairer version of the trained machine learning model, the back-end computing platform 102 may select a given candidate instance of the subpopulation-independent fairer version of the trained machine learning model. In this respect, the function of selecting the given candidate instance of the subpopulation-independent fairer version of the trained machine learning model may take any of various forms, including but not limited to any of the various forms described above.

Thereafter, the given candidate instance of the subpopulation-independent fairer version of the trained machine learning model may be deployed and utilized to output predicted values of the at least one numerical variable. Further, in at least some implementations, the predicted values of the at least one numerical variable that are output by the given candidate instance of the subpopulation-independent fairer version of the trained machine learning model may be explained using a model explainability technique.

As noted, the functionality 600 may take various other forms as well. For instance, it is possible that the functionality 600 may include additional and/or different functions than those shown in FIG. 6, including but not limited to any additional and/or different functions that are described above.

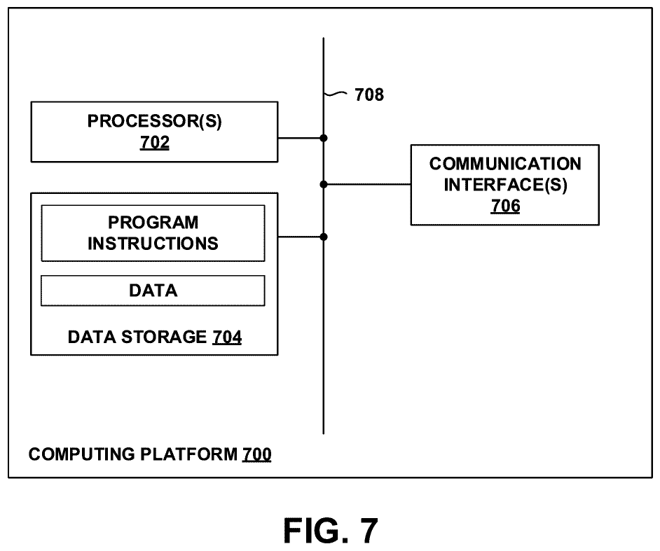

Turning now to FIG. 7, a simplified block diagram is provided to illustrate some structural components that may be included in an example computing platform 700 that may be configured perform some or all of the functions discussed herein for creating a data science model in accordance with the present disclosure. At a high level, computing platform 700 may generally comprise any one or more computer systems (e.g., one or more servers) that collectively include one or more processors 702, data storage 704, and one or more communication interfaces 706, all of which may be communicatively linked by a communication link 708 that may take the form of a system bus, a communication network such as a public, private, or hybrid cloud, or some other connection mechanism. Each of these components may take various forms.

For instance, the one or more processors 702 may comprise one or more processor components, such as one or more central processing units (CPUs), graphics processing unit (GPUs), application-specific integrated circuits (ASICs), digital signal processor (DSPs), and/or a programmable logic devices such as a field programmable gate arrays (FPGAs), among other possible types of processing components. In line with the discussion above, it should also be understood that the one or more processors 702 could comprise processing components that are distributed across a plurality of physical computing devices connected via a network, such as a computing cluster of a public, private, or hybrid cloud.

In turn, data storage 704 may comprise one or more non-transitory computer-readable storage mediums, examples of which may include volatile storage mediums such as random-access memory, registers, cache, etc. and non-volatile storage mediums such as read-only memory, a hard-disk drive, a solid-state drive, flash memory, an optical-storage device, etc. In line with the discussion above, it should also be understood that data storage 704 may comprise computer-readable storage mediums that are distributed across a plurality of physical computing devices connected via a network, such as a storage cluster of a public, private, or hybrid cloud that operates according to technologies such as AWS for Elastic Compute Cloud, Simple Storage Service, etc.

As shown in FIG. 7, data storage 704 may be capable of storing both (i) program instructions that are executable by processor 702 such that the computing platform 700 is configured to perform any of the various functions disclosed herein (including but not limited to any the functions described above with reference to FIGS. 2-5), and (ii) data that may be received, derived, or otherwise stored by computing platform 700.

The one or more communication interfaces 706 may comprise one or more interfaces that facilitate communication between computing platform 700 and other systems or devices, where each such interface may be wired and/or wireless and may communicate according to any of various communication protocols, examples of which may include Ethernet, Wi-Fi, serial bus (e.g., Universal Serial Bus (USB) or Firewire), cellular network, and/or short-range wireless protocols, among other possibilities.

Although not shown, the computing platform 700 may additionally include or have an interface for connecting to one or more user-interface components that facilitate user interaction with the computing platform 700, such as a keyboard, a mouse, a trackpad, a display screen, a touch-sensitive interface, a stylus, a virtual-reality headset, and/or one or more speaker components, among other possibilities.

It should be understood that computing platform 700 is one example of a computing platform that may be used with the embodiments described herein. Numerous other arrangements are possible and contemplated herein. For instance, other computing systems may include additional components not pictured and/or more or less of the pictured components.

### CONCLUSION

This disclosure makes reference to the accompanying figures and several example embodiments. One of ordinary skill in the art should understand that such references are for the purpose of explanation only and are therefore not meant to be limiting. Part or all of the disclosed systems, devices, and methods may be rearranged, combined, added to, and/or removed in a variety of manners without departing from the true scope and spirit of the present invention, which will be defined by the claims.

Further, to the extent that examples described herein involve operations performed or initiated by actors, such as “humans,” “curators,” “users” or other entities, this is for purposes of example and explanation only. The claims should not be construed as requiring action by such actors unless explicitly recited in the claim language.

We claim:

1. A computing platform comprising:
at least one network interface for communicating over at least one data network;
at least one processor;
at least one non-transitory computer-readable medium; and
program instructions stored on the at least one non-transitory computer-readable medium that, when executed by the at least one processor, cause the computing platform to:
utilize a first machine learning process to train a machine learning model that is configured to (i) receive an input record comprising feature values for an input set of features and (ii) output an unadjusted predicted value for at least one numerical variable;
initialize a subpopulation-dependent fairer version of the trained machine learning model that is configured to (i) receive an input record comprising feature values for the input set of features and a subpopulation value indicating that the input record is associated with a particular subpopulation from a group of distinct subpopulations and (ii) output a fairness-adjusted predicted value for the at least one numerical variable that is dependent on the subpopulation value;
utilize a second machine learning process to train a subpopulation-independent projection of the subpopulation-dependent fairer version of the trained machine learning model that is configured to (i) receive an input record comprising feature values for the input set of features and (ii) output a fairness-adjusted predicted value for the at least one numerical variable without relying on any subpopulation value;
evaluate multiple candidate instances of a subpopulation-independent fairer version of the trained machine learning model comprising a linear combination of (i) an unadjusted predicted value for the at least one numerical variable that is output by the trained machine learning model and (ii) a fairness-adjusted predicted value for the at least one numerical variable that is output by the subpopulation-independent projection, wherein each respective candidate instance of the subpopulation-independent fairer version of the trained machine learning model applies a different weighting to the unadjusted and fairness-adjusted predicted values within the linear combination; and
based on evaluating the multiple candidate instances of the subpopulation-independent fairer version of the trained machine learning model, select a given candidate instance of the subpopulation-independent fairer version of the trained machine learning model, wherein the subpopulation-independent fairer version of the trained machine learning model is thereafter deployed.

2. The computing platform of claim 1, wherein the at least one numerical variable comprises a classification score for use in making a binary classification prediction between a positive outcome and a negative outcome.

3. The computing platform of claim 2, wherein the second machine learning process comprises a machine learning process involving a supervised learning technique that minimizes a weighted loss function.

4. The computing platform of claim 3, wherein the weighted loss function quantifies performance loss in terms of binary cross-entropy.

5. The computing platform of claim 3, wherein the second machine learning process is applied to a collection of training-record pairs, and wherein each respective training-record pair comprises:
a first training record containing a respective set of feature values for the input set of features, a first label for a positive outcome, and a first weight comprising a fairness-adjusted classification score output by the subpopulation-dependent fairer version of the trained machine learning model for the respective set of feature values given a corresponding subpopulation value; and
a second training record containing the respective set of feature values for the input set of features, a second label for a negative outcome, and a second weight comprising a complement of the fairness-adjusted classification score output by the subpopulation-dependent fairer version of the trained machine learning model for the respective set of feature values given the corresponding subpopulation value.

6. The computing platform of claim 2, wherein the subpopulation-dependent fairer version of the trained machine learning model comprises a mapping function that is configured to map an unadjusted classification score output by the trained machine learning model to a point along a distribution of fairness-adjusted classification scores that constitutes a combination of subpopulation-specific distributions of unadjusted classification scores output by the trained machine learning model for the group of distinct subpopulations.

7. The computing platform of claim 6, wherein the distribution of fairness-adjusted classification scores comprises a weighted Wasserstein-2 barycenter.

8. The computing platform of claim 1, wherein the subpopulation-independent projection of the subpopulation-dependent fairer version of the trained machine learning model comprises a trained machine learning model having an output that is explainable by a model explainability technique.

9. The computing platform of claim 1, wherein the program instructions that, when executed by the at least one processor, cause the computing platform to evaluate the multiple candidate instances of the subpopulation-independent fairer version of the trained machine learning model comprise program instructions that, when executed by the at least one processor, cause the computing platform to:
evaluate the multiple candidate instances of the subpopulation-independent fairer version of the trained machine learning model based on respective performance and bias values that are determined for each of the multiple candidate instances of the subpopulation-independent fairer version of the trained machine learning model.

10. The computing platform of claim 1, further comprising program instructions stored on the at least one non-transitory computer-readable medium that, when executed by the at least one processor, cause the computing platform to:
after deploying the given candidate instance of the subpopulation-independent fairer version of the trained machine learning model, utilize the given candidate instance of the subpopulation-independent fairer version of the trained machine learning model to render predictions comprising predicted values of the at least one numerical variable for individuals or other entities within a population comprising the group of distinct subpopulations; and
for each of at least a subset of the predictions rendered by the given candidate instance of the subpopulation-independent fairer version of the trained machine learning model, utilize a model explainability technique to explain the prediction.

11. A non-transitory computer-readable medium, wherein the non-transitory computer-readable medium is provisioned with program instructions that, when executed by at least one processor, cause a computing platform to:
utilize a first machine learning process to train a machine learning model that is configured to (i) receive an input record comprising feature values for an input set of features and (ii) output an unadjusted predicted value for at least one numerical variable;
initialize a subpopulation-dependent fairer version of the trained machine learning model that is configured to (i) receive an input record comprising feature values for the input set of features and a subpopulation value indicating that the input record is associated with a particular subpopulation from a group of distinct subpopulations and (ii) output a fairness-adjusted predicted value for the at least one numerical variable that is dependent on the subpopulation value;
utilize a second machine learning process to train a subpopulation-independent projection of the subpopulation-dependent fairer version of the trained machine learning model that is configured to (i) receive an input record comprising feature values for the input set of features and (ii) output a fairness-adjusted predicted value for the at least one numerical variable without relying on any subpopulation value;
evaluate multiple candidate instances of a subpopulation-independent fairer version of the trained machine learning model comprising a linear combination of (i) an unadjusted predicted value for the at least one numerical variable that is output by the trained machine learning model and (ii) a fairness-adjusted predicted value for the at least one numerical variable that is output by the subpopulation-independent projection, wherein each respective candidate instance of the subpopulation-independent fairer version of the trained machine learning model applies a different weighting to the unadjusted and fairness-adjusted predicted values within the linear combination; and
based on evaluating the multiple candidate instances of the subpopulation-independent fairer version of the trained machine learning model, select a given candidate instance of the subpopulation-independent fairer version of the trained machine learning model, wherein the subpopulation-independent fairer version of the trained machine learning model is thereafter deployed.

12. A method carried out by a computing platform, the method comprising:
utilizing a first machine learning process to train a machine learning model that is configured to (i) receive an input record comprising feature values for an input set of features and (ii) output an unadjusted predicted value for at least one numerical variable;
initializing a subpopulation-dependent fairer version of the trained machine learning model that is configured to (i) receive an input record comprising feature values for the input set of features and a subpopulation value indicating that the input record is associated with a particular subpopulation from a group of distinct subpopulations and (ii) output a fairness-adjusted predicted value for the at least one numerical variable that is dependent on the subpopulation value;
utilizing a second machine learning process to train a subpopulation-independent projection of the subpopulation-dependent fairer version of the trained machine learning model that is configured to (i) receive an input record comprising feature values for the input set of features and (ii) output a fairness-adjusted predicted value for the at least one numerical variable without relying on any subpopulation value;
evaluating multiple candidate instances of a subpopulation-independent fairer version of the trained machine learning model comprising a linear combination of (i) an unadjusted predicted value for the at least one numerical variable that is output by the trained machine learning model and (ii) a fairness-adjusted predicted value for the at least one numerical variable that is output by the subpopulation-independent projection, wherein each respective candidate instance of the subpopulation-independent fairer version of the trained machine learning model applies a different weighting to the unadjusted and fairness-adjusted predicted values within the linear combination; and
based on evaluating the multiple candidate instances of the subpopulation-independent fairer version of the trained machine learning model, selecting a given candidate instance of the subpopulation-independent fairer version of the trained machine learning model, wherein the subpopulation-independent fairer version of the trained machine learning model is thereafter deployed.

13. The method of claim 12, wherein the at least one numerical variable comprises a classification score for use in making a binary classification prediction between a positive outcome and a negative outcome.

14. The method of claim 13, wherein the second machine learning process comprises a machine learning process involving a supervised learning technique that minimizes a weighted loss function.

15. The method of claim 14, wherein the weighted loss function quantifies performance loss in terms of binary cross-entropy.

16. The method of claim 14, wherein the second machine learning process is applied to a collection of training-record pairs, and wherein each respective training-record pair comprises:
a first training record containing a respective set of feature values for the input set of features, a first label for a positive outcome, and a first weight comprising a fairness-adjusted classification score output by the subpopulation-dependent fairer version of the trained machine learning model for the respective set of feature values given a corresponding subpopulation value; and
a second training record containing the respective set of feature values for the input set of features, a second label for a negative outcome, and a second weight comprising a complement of the fairness-adjusted classification score output by the subpopulation-dependent fairer version of the trained machine learning model for the respective set of feature values given the corresponding subpopulation value.

17. The method of claim 13, wherein the subpopulation-dependent fairer version of the trained machine learning model comprises a mapping function that is configured to map an unadjusted classification score output by the trained machine learning model to a point along a distribution of fairness-adjusted classification scores that constitutes a combination of subpopulation-specific distributions of unadjusted classification scores output by the trained machine learning model for the group of distinct subpopulations.

18. The method of claim 12, wherein the subpopulation-independent projection of the subpopulation-dependent fairer version of the trained machine learning model comprises a trained machine learning model having an output that is explainable by a model explainability technique.

19. The method of claim 12, wherein evaluating the multiple candidate instances of the subpopulation-independent fairer version of the trained machine learning model comprises:
evaluating the multiple candidate instances of the subpopulation-independent fairer version of the trained machine learning model based on respective performance and bias values that are determined for each of the multiple candidate instances of the subpopulation-independent fairer version of the trained machine learning model.

20. The method of claim 12, further comprising:
after deploying the given candidate instance of the subpopulation-independent fairer version of the trained machine learning model, utilizing the given candidate instance of the subpopulation-independent fairer version of the trained machine learning model to render predictions comprising predicted values of the at least one numerical variable for individuals or other entities within a population comprising the group of distinct subpopulations; and
for each of at least a subset of the predictions rendered by the given candidate instance of the subpopulation-independent fairer version of the trained machine learning model, utilizing a model explainability technique to explain the prediction.
